(19) United States
(12) Patent Application Publication
(10) Pub. No.: US 2015/0143256 A1
(43) Pub. Date: May 21, 2015

(54) Interface for Interaction with a Compendium by Members of a Group

(71) Applicant: Memoreze LLC, Saratoga, CA (US)

(72) Inventors: Deepti Panchawagh-Jain, San Jose, CA (US); Smita Srivastava Dharmaraj, Saratoga, CA (US); Vivek Jain, San Jose, CA (US)

(21) Appl. No.: 14/541,055

(22) Filed: Nov. 13, 2014

Related U.S. Application Data
(60) Provisional application No. 61/906,873, filed on Nov. 20, 2013.

(51) Int. Cl. H04L 12/58; G06F 3/0484

(52) U.S. Cl. CPC H04L 51/08; G06F 3/04842
USPC 715/752

(57) ABSTRACT

A system, method, and user interface for interacting with digital yearbooks, memory books, or other types of photo books via a smartphone or tablet (device). Electronic books can be viewed easily on the user's device. Signatures for the book can be requested from other members of the group, and signatures can be created in others' books integrating various multi-media elements, straight from the user's device. Electronic books with collages on different pages can also be created easily on the device. Such books can also be created collaboratively by a number of users. The users can also communicate with each other as a group, or provide signatures for each other.

### CROSS-REFERENCE TO RELATED APPLICATIONS

This application claims the benefit of U.S. patent application No. 61/906,873, filed on Nov. 20, 2013, and which is entitled “System, Method, and User Interface for Interaction with a Compendium by Members of a Group”, which is hereby incorporated by reference herein in its entirety.

### BACKGROUND

1. Field of the Art

The present disclosure generally relates to electronic books, and more particularly to systems, methods and user interfaces for interaction, via electronic devices, with a memory book by members of a group.

2. Description of the Related Art

Yearbooks, memory books, photo books etc. have long been treasured and valued. They preserve memories that are precious in the form of photos, notes, messages, signatures, etc.

However, despite the widespread advent of personal devices such as smartphones, iTouch type devices, tablets, and phablets, such books have not evolved significantly.

By way of example, yearbooks have been around for multiple decades, and they still continue to abound in much the same form—that of a big book that is published annually, and in which students obtain signatures from other students.

There are several problems with a traditional yearbook. First, such books are often large and cumbersome, and such physically printed books use a significant amount of paper. This goes counter to the environment-friendly and green products that are desired by many today. Second, such yearbooks are very frequently misplaced soon after they are obtained. As a result, it is difficult if not impossible to locate such yearbooks several years later. Along with the lost yearbook, the signatures/messages from friends (treasured memories) that were obtained in the yearbook are also lost. Yet another problem is that students often get the yearbook only a few days before the end of the school year, and as a result do not have enough time to obtain signatures from all the people they want. Another issue is that since there is a fair amount of time needed to print the books, the book must be submitted to the printing press several weeks (even months) prior to distribution. This means that any event that occurs in those weeks is not captured in the printed book. Further, if students want to include photographs along with their signatures, they need to obtain physical copies of the photos, cut them to size and then attach (using tape, glue or a stapler) them along with their notes or signatures. Including video and audio is not really possible. Attempts to include video revolve around pasting in QR codes, but this is not elegant, and requires a lot of overhead.

Others have attempted to upload yearbooks online. These uploads are on websites that just encourage people to upload their yearbooks, so others can also see the yearbook from a particular school for a certain year. However, a specific individual's yearbook is not uploaded, but rather just a yearbook from someone else in the same school. Thus signatures received from specific friends are completely missing. Also, attempts at electronic yearbooks simply present the yearbook in a digital format, but lose out completely on the treasured experience of asking for friends' signatures, and signing in friends' yearbooks.

By way of another example is a different type of memory book, specifically, a family reunion. It is highly likely that several of the people present at the family reunion will take photos and/or videos. These photos etc. are often taken from each person's personal device (such as a smartphone, tablet, phablet, and so on). The people involved will want to consolidate these photos, videos, audio files etc. There may also be a need to include captions or other types of text to supplement the multi-media files. Currently, there is no easy way to quickly and collaboratively create a memory book from such multi-media files.

At most, people will upload their photos to a photo-sharing service such as SHUTTERFLY or PICASA, or use some platform-specific features such as the ICLOUD PHOTO SHARING. All of these options have multiple drawbacks. For example, the ICLOUD PHOTO SHARING feature is specific to the iOS platform and therefore is not something that can be used to share photos amongst people who use personal devices on other platforms (such as Android). Also, there do not appear to be collages that can be easily created. SHUTTERFLY service does not appear to allow for multiple people to upload photos to the same photo album—each album belongs to the user who creates it, and only by logging in to the that user's account can additional photos be added. Moreover, in a digital context, it is not possible to view various photo collages as pages in a memory book. Instead these services only offer a simple photo by photo slide show for digital presentation, or at most single collages. This appears to be true for Picasa as well. Photo books with collages are allowed only in the printed form. Further still, with these services it is not possible in the digital context to add text/captions along with multiple pictures in a page in a book type of visual presentation. Numerous apps (such as INSTACOLLAGE, PICPLAYPOST, and PICCOLLAGE, to name a few), allow for creation of collages on smartphones etc. However, none of these allow for a collection of collages which is collectively presented as a book.

Furthermore, it does not appear that these services allow for interaction between the various members of the group in the context of the memory book. For instance, there is no person-to-person communication in the context of a specific memory book, and/or no group discussion for a group that is created around a specific memory book.

Therefore there is a need for a system, method and user interface for an electronic photo collage book which can be created dynamically and/or collaboratively by a group that can be created dynamically, and where the members of the group can communicate with each other. There is also a need for a system, method and user interface for a digital yearbook memory book and/or photo collage book which allows for true multimedia integration, and which can provide for requesting and creating signatures in the yearbook.

### BRIEF DESCRIPTION OF THE DRAWINGS

FIG. 1A shows a system in accordance with an example embodiment.

FIG. 1B is a block diagram of the various modules in a system in accordance with an example embodiment.

FIG. 2A shows how a user can create an account in accordance with an example embodiment.

FIG. 2B shows how parental consent may be required in some instances, in accordance with an example embodiment.

FIG. 2C shows how a user can create a userid and password in accordance with an embodiment of the present invention.

FIG. 2D how the userid and password can be used for access in accordance with an example embodiment.

FIG. 3A shows a block diagram of the options available to a user in accordance with an example embodiment.

FIG. 3B shows that only limited functionalities may be available to some users in accordance with an example embodiment.

FIGS. 4A-4F show various view of a yearbook on a user's device in accordance with an example embodiment.

FIG. 4G shows multiple signature combined into a single view in accordance with an example embodiment.

FIG. 4H shows a different way of viewing signatures in accordance with an example embodiment.

FIG. 4I shows a notification provided if no signatures are received, in accordance with an example embodiment.

FIG. 4J shows a view of a single signature in accordance with an example embodiment.

FIG. 4K is a flowchart that shows how multiple signatures may be presented in accordance with an example embodiment.

FIG. 5A shows photographs of the members of a group in accordance with an example embodiment.

FIG. 5B shows how a signature can be requested in accordance with an example embodiment.

FIG. 5C shows an updated status being provided to the user in accordance with an example embodiment.

FIG. 5D shows how a visual indication may be provided to the user based on the status in accordance with an example embodiment.

FIGS. 5E-5F show updated statuses in accordance with an example embodiment.

FIG. 5G shows a summary of interaction between the user and another group member in accordance with an example embodiment.

FIG. 5H is a flowchart which illustrates how signatures may be requested in accordance with an example embodiment.

FIG. 6A shows pending signature requests received in accordance with an example embodiment.

FIG. 6B shows a notification screen that is shown if no signature requests have been received, in accordance with an example embodiment.

FIG. 7A shows the options available for creating a signature in accordance with an example embodiment.

FIGS. 7B-7F show various details associated with different options for creating a signature in accordance with an example embodiment.

FIG. 7G shows an example of a signature created in accordance with an example embodiment.

FIG. 8 shows an account information page in accordance with an example embodiment.

FIG. 9 shows interaction between two users in accordance with an example embodiment.

FIG. 10A shows the options available to a user in accordance with an example embodiment.

FIG. 10B shows some examples of templates in accordance with an example embodiment.

FIG. 11A is a flowchart that shows the Easy Create option in accordance with an example embodiment.

FIG. 11B shows a page with different types of data in accordance with an example embodiment.

FIG. 12A is an example of a bookshelf with photobooks on a user's device in accordance with an example embodiment.

FIG. 12B is an example of a user interface with photobooks on a user's device in accordance with an example embodiment.

FIG. 13 is a flowchart that shows how users can join a group in accordance with an example embodiment.

FIG. 14 is an example of how person-to-person communications can be managed from a single screen in accordance with an example embodiment.

FIG. 15 shows a page in a collage book in accordance with an example embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

In various places in this document, the group-based compendium, book, brochure or other compilation may be referred to as a yearbook, for a school, college or any other educational institution, and the user(s) may be referred to as a student (or staff member). However, it is to be noted that such references are purely for convenience and illustration purposes, and the various embodiments of the present invention are not limited to a yearbook, and the users are not limited to students or staff. In particular, various embodiments of the present invention include various other group-based books, memory books, brochures, or other compilations. Examples of the group-based books, brochures, or other compilations being viewed, signed, edited etc. can include, but are not limited to, yearbooks, graduation books, club books, books for businesses/companies, church group books, vacation books, college reunion books, family reunion books, memory books for other events (such as weddings, dances, parties) and other groups or organizations (e.g., community-based or institution-based groups, wedding parties, families, groups of friends, and so on).

Example embodiments disclosed relate to electronically signing, viewing, editing and/or otherwise interacting with a group-based compendium such as a book, brochure, or other compilation. Some example embodiments relate to creation of a group-based compendium collaboratively by members of the group.

Various example embodiments relate to students requesting signatures from other students in a yearbook. Both the requesting and the signing is done electronically in an application (app) on a smart mobile device. In one embodiment, the group of students is a predefined group, and signatures cannot be requested from those outside the group. In one embodiment, a convenient user interface allows students to visually select which students to ask for signatures, and a notification is created for those receiving the signature requests. Those receiving the notifications can then respond to the signature requests by creating a rich signature using various modalities (including but not limited to free-hand drawing, text, photographs, video and audio, stickers and stamps).

In some example embodiments, a predefined group may be, for example, players in a sports team or league, people in a church, people in a wedding party and so on. In some example embodiments, the compendium is a collection of memories, and can include, but is not limited to, text, photographs and other images, video, audio, and so on.

In some example embodiments, the group is predefined. In other example embodiments, the group is built dynamically as one or more members of the group invite other people to join the group.

In some example embodiments, the compendium is created by some or all members of the group. In some embodiments, this compendium is created on a collaborative basis, where one (or more) member(s) of the group starts the compendium, and others in the group add on to it. In some embodiments, the compendium can be created very quickly and efficiently by the user simply selecting content (including multi-media content) on the user's device for inclusion in the compendium. In some embodiments, the compendium is pre-created. In some embodiments, the compendium is created by people outside the group. In some embodiments, a portion of the compendium is pre-created, while a portion of the compendium is created dynamically. In some embodiments, the compendium is a collection of various collages.

In some example embodiments, communications are on a one-to-one level. Examples of such communication can include signatures by one group-member in another group member's memory book. In some embodiments, communications are at a group level, and are visible to everyone in the group. Examples of such communication can include a group chat.

### Example System Overview

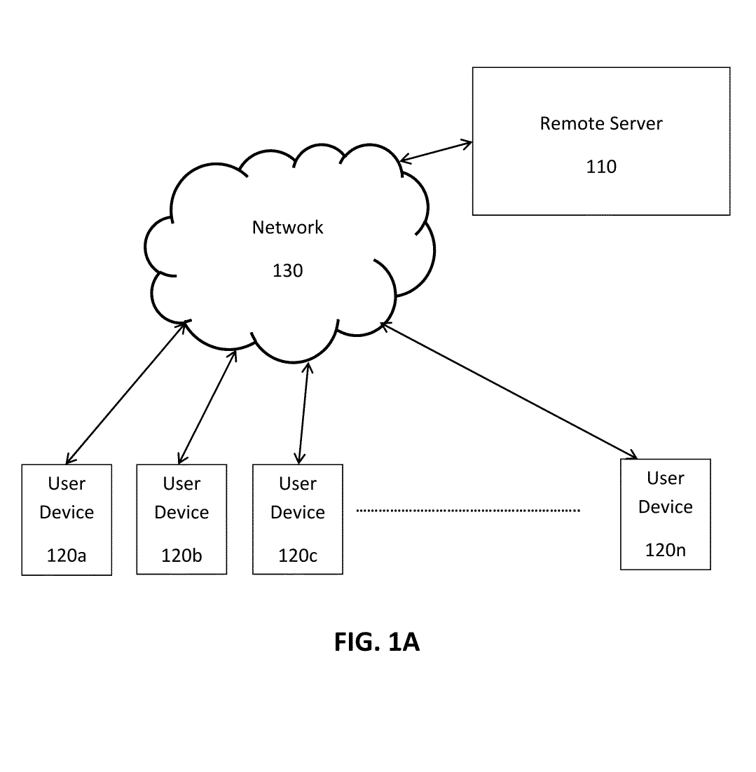

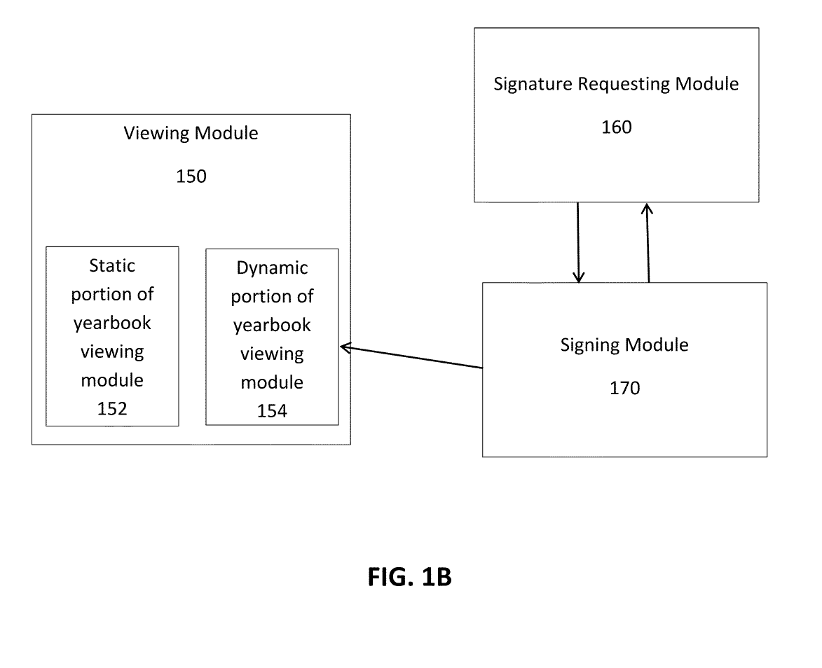

FIG. 1A shows a system in accordance with an example embodiment. In accordance with an embodiment, some information and/or intelligence may reside on a remote server (110), while some information and/or intelligence may reside on a user's device (120). Several user devices (120a, 120b, . . . , 120n) communicate with the remote server (110) via a network (130). The network (130) may be a WiFi network, a wired network, a cellular network, a home network, a LAN, any combination of any such networks, and so on. The user devices 160 include a processor, a memory, a non-transitory computer readable storage (e.g., solved state or magnetic hard drive), and network communications subsystems. The processes described herein can be stored as instructions in the memory and computer readable medium and are executable by the processor.

In one embodiment, the remote server (110) hosts some intelligence and/or databases. In one embodiment the remote server (110) is a single server. In one embodiment, the remote server (110) is not a single server, but may rather be a combination of several different servers. In one such embodiment, one server may be used for data storage, while another server may be used for intelligence and/or database hosting. The remote server (110) may be owned by one or more third parties.

The user device (120) on which the yearbook is viewed and/or interacted with by the user may be any electronic device, including but not limited to, mobile devices such as smartphones (e.g., APPLE iPhones, ANDROID based phones, BLACKBERRY phones, etc.), tablets (e.g., APPLE IPAD, APPLE IPAD mini, SAMSUNG GALAXY, GOOGLE NEXUS, etc.), and phablets (e.g., APPLE IPHONE 6 PLUS). The user device (120) may be a touch-sensitive device and include a touch screen, touch pad, or other modalities of touch-based interaction. The user device (120) may include or be able to communicate with a camera or other modalities of image and/or video based interaction. The user device (120) may include or be able to communicate with a microphone or other modalities of audio-based interaction. An example of an audio-based interaction is SIRI on the IPHONE. In one embodiment, some of the information residing on the user device (120) and the user interfaces (UI) discussed herein are in the form of an app on a mobile device. In one embodiment, the user device (120) uses operating systems such as iOS, ANDROID, and so on. In one embodiment, the user device is a personal computer, laptop, etc.

FIG. 1B is a block diagram of the various modules in a system in accordance with an example embodiment. It is comprised of a viewing module (150), a signature requesting module (160), and a signing module (170).

In one embodiment, the viewing module (150) is comprised of a static portion of the yearbook viewing module (152) and a dynamic portion of the yearbook viewing module (154). The static portion of the yearbook is not modifiable by any user, and remains as is. For instance, in one embodiment, the static portion of the yearbook comprises of student portraits and associated information (e.g., student names, grades, etc.). In one embodiment, the static portion of the yearbook comprises of school events. The users can only read or view this portion of the yearbook during regular use of an app in accordance with an embodiment of the present invention. It is to be noted that in one embodiment, an administrator (who may also be a user) is able to modify the static portion of the yearbook.

The dynamic portion of the yearbook is modifiable by the users. For instance, in one example embodiment, the dynamic portion of the yearbook comprises of signatures created by users. It is to be understood that “signature(s)” here may include, but is not limited to, official signatures. Rather, the term encompasses any message or information that one user wishes to communicate to another. Further details on what a signature can comprise are elaborated on below.

It is also to be noted that in one embodiment, some or all of the dynamic portion of the yearbook is merged with the static portion of the yearbook, to create a revised static portion of the yearbook. For instance, in accordance with an example embodiment, one or more signatures are included on a signature page, and this signature page is then not modifiable by users any more. These completed signature pages then become part of the static portion of the yearbook, and can be viewed but not modified further.

In one embodiment, there is no static portion of the yearbook, and the entire yearbook is dynamically modifiable. In such an embodiment, the viewing module 150 will not include the static portion of the yearbook viewing module 152. As an example, users may be able to modify and/or annotate any of the pages in the yearbook, or any subset thereof. Such an embodiment is discussed in more detail below.

In one example embodiment, there is no dynamic portion of the yearbook, and the entire yearbook is static. In such an embodiment, the viewing module 150 will not include the dynamic portion of the yearbook viewing module 154.

In one embodiment, there is no viewing module (150), and just the signature requesting module (160) and the signing module (170) exist. In one embodiment, just the signature requesting module (160) exists. In one embodiment, the signature requesting module (160) is a user interface for seamless communication with any of a group of users. In one embodiment, just the signing module (170) exists.

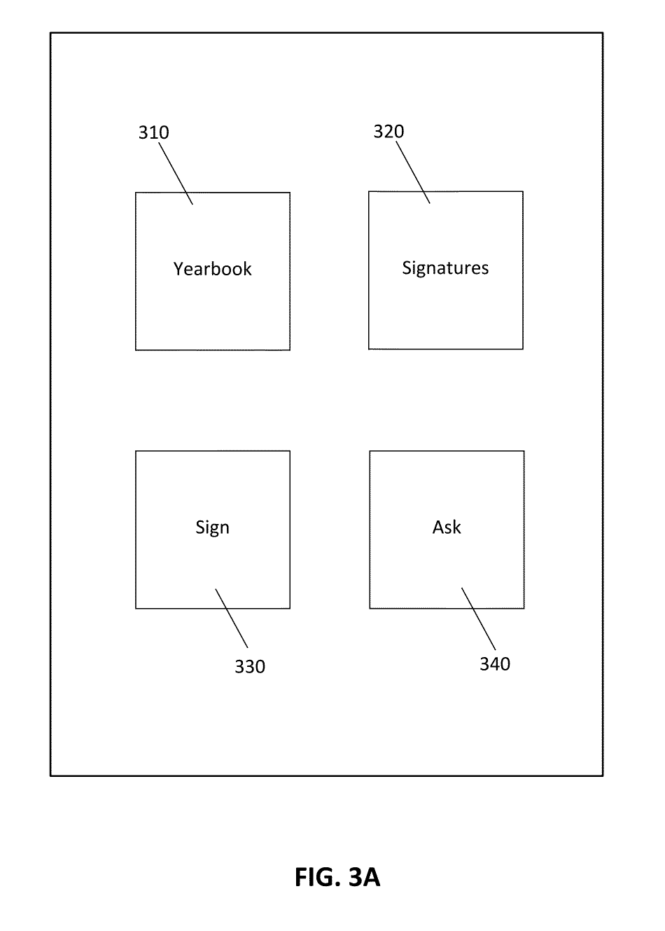

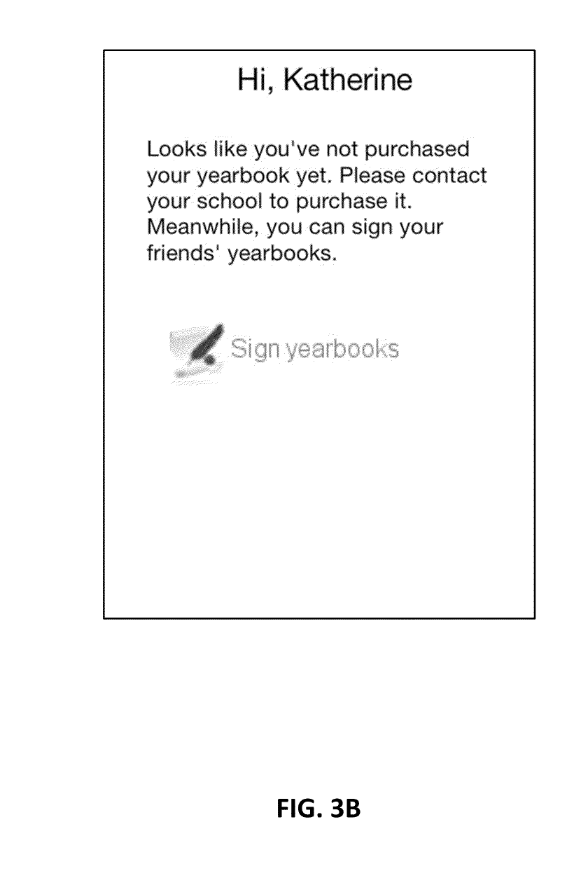

As an example of a situation where only some, but not all, modules are available for some users, consider a situation when some users are not eligible to view the book. For instance, this may be the situation if a student has not purchased a yearbook. In such a situation, the student cannot view the yearbook, or request signatures for his/her yearbook. However, such a student can still sign other students' yearbooks. In one embodiment, such a student can only receive signature requests from other students, and then respond to those requests by creating a signature for those students' yearbooks. This is discussed in further detail below in the context of FIGS. 3A and 3B.

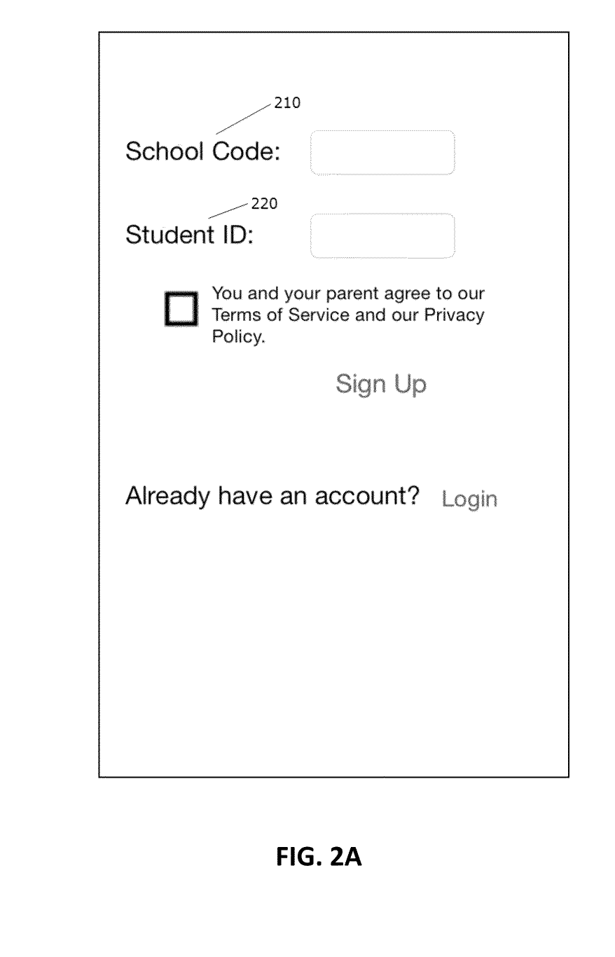

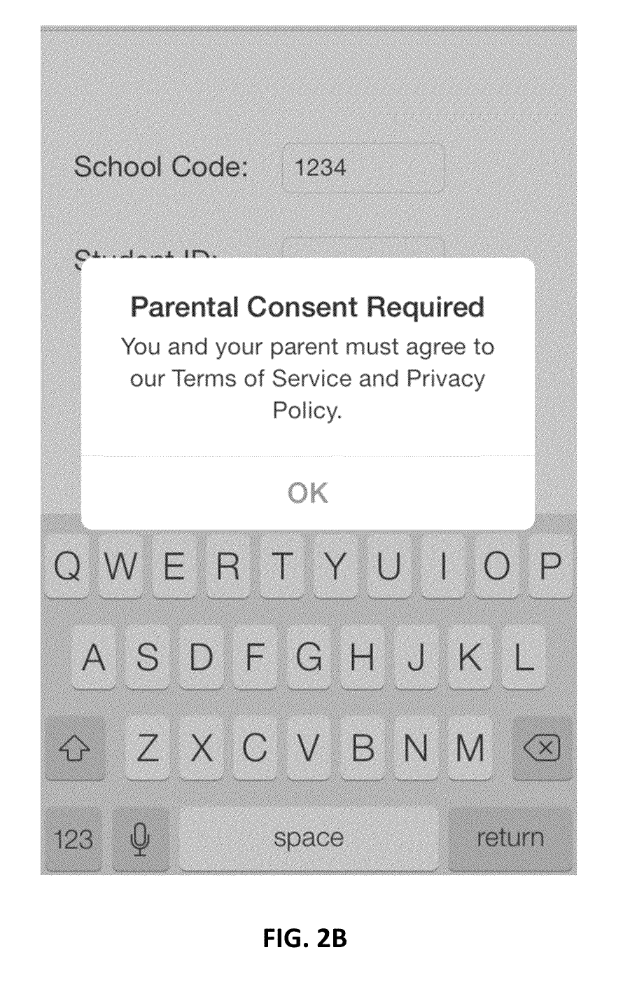

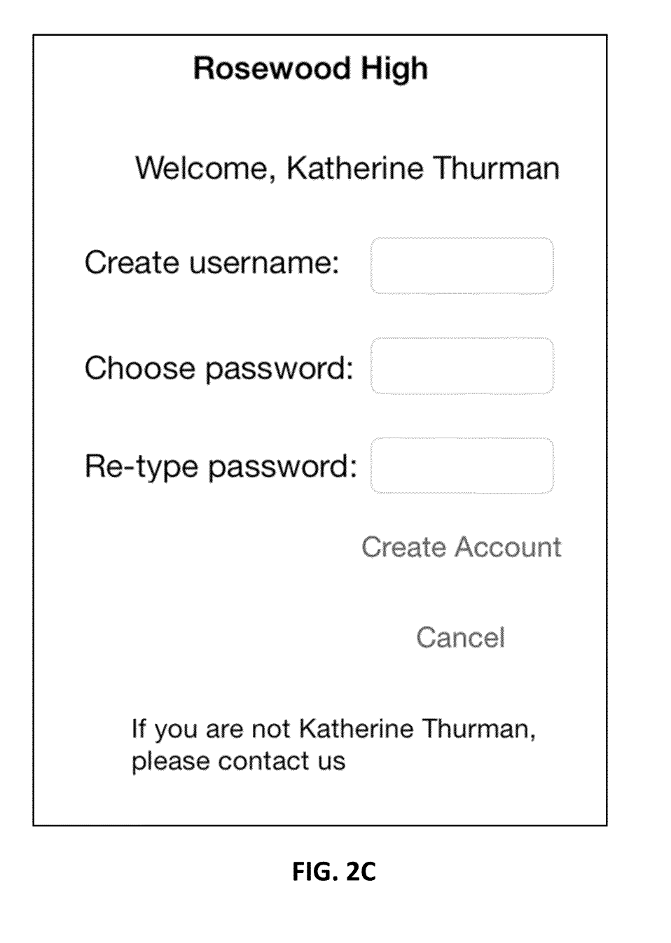

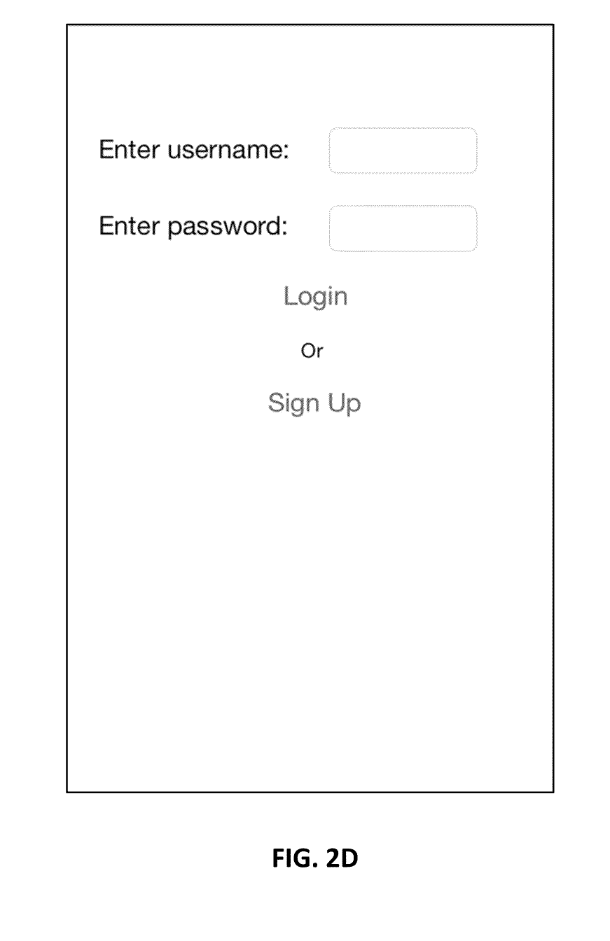

In accordance with one example embodiment, a user can use some functionalities only if the organization or group to which the users belong has permitted use of these functionalities. For example, in accordance with one embodiment, a school needs to allow the use of a mobile application by its students. In accordance with an example embodiment, each group or organization is assigned a unique identifier. The group provides this unique identifier to its members. Referring to FIG. 2A, it can be seen that the members can create an account using the unique identifier (210) and a unique identifier (220) for the member himself. For instance, in one embodiment, if the organization is a school, the unique identifier for the member is a student id. In other instances, this unique identifier is a membership number, account number, or even a name. In one embodiment, the unique identifier for each user is also provided, in addition to the organization identifier.

In one embodiment, agreement by the user and his/her parent or guardian to specific terms, and/or consent by the user and his/her parent or guardian to using the application is required before the app can be used. This is specifically relevant in the context of use of the application by minors. See FIG. 2B.

During the creation of the account, in one embodiment, a user can create a userid and password (FIG. 2C), which can then be used subsequently by the user to access the application (FIG. 2D).

In accordance with one example embodiment, the features, functionalities and/or options available to a specific user may be determined by the status of the user within the group, or based upon certain parameters. For instance, a student who has paid to purchase a yearbook may be provided with options to view the yearbook and to request signatures (as well as to sign yearbooks etc.) as seen in FIG. 3A, while a student who has not paid to purchase a yearbook may be provided only with a subset of the features (e.g., responding to requests to sign from other students by signing their yearbooks), while other functionalities (e.g., viewing the yearbook, requesting signatures, etc.) may be unavailable and/or disabled for such students. This can be seen in FIG. 3B. Another example is that the principal of a school may have access to view the books of various student activity clubs. In another embodiment, some members of the group may have different sets of options, features and/or functionalities altogether, based on certain parameters.

Referring back to FIG. 3A, which shows the options a user sees after creating an account and/or logging in. It can be seen that in the embodiment shown here, the user is provided with the options of viewing the yearbook (310), viewing signatures (320), signing yearbooks (330), or asking friends to sign (340).

### Viewing

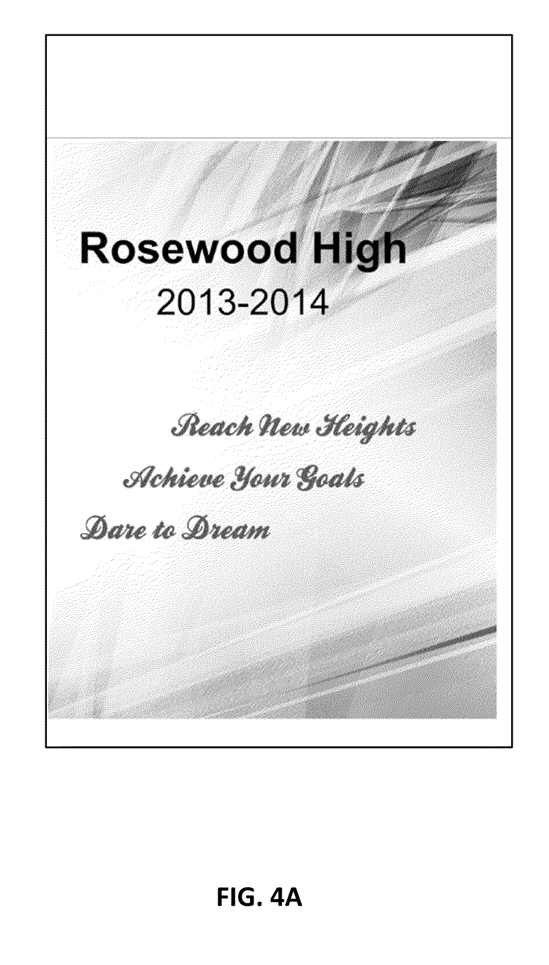

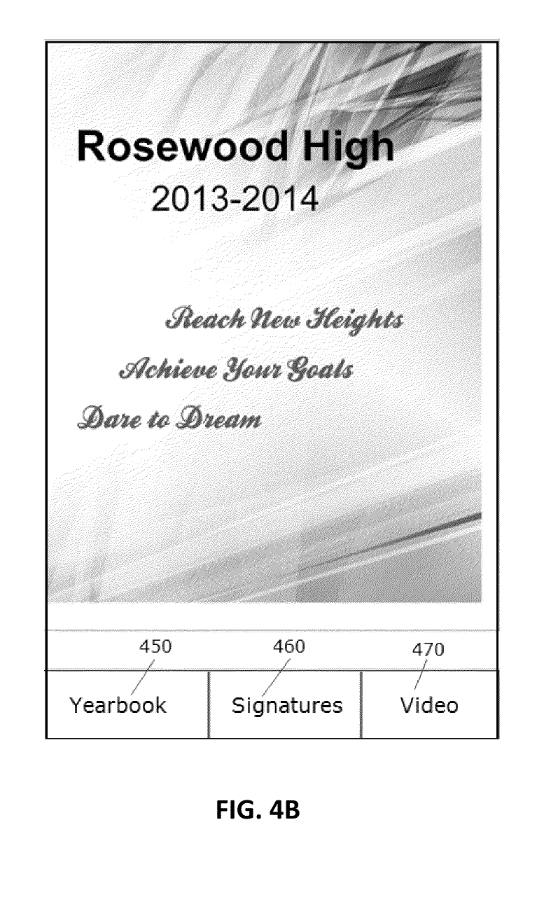

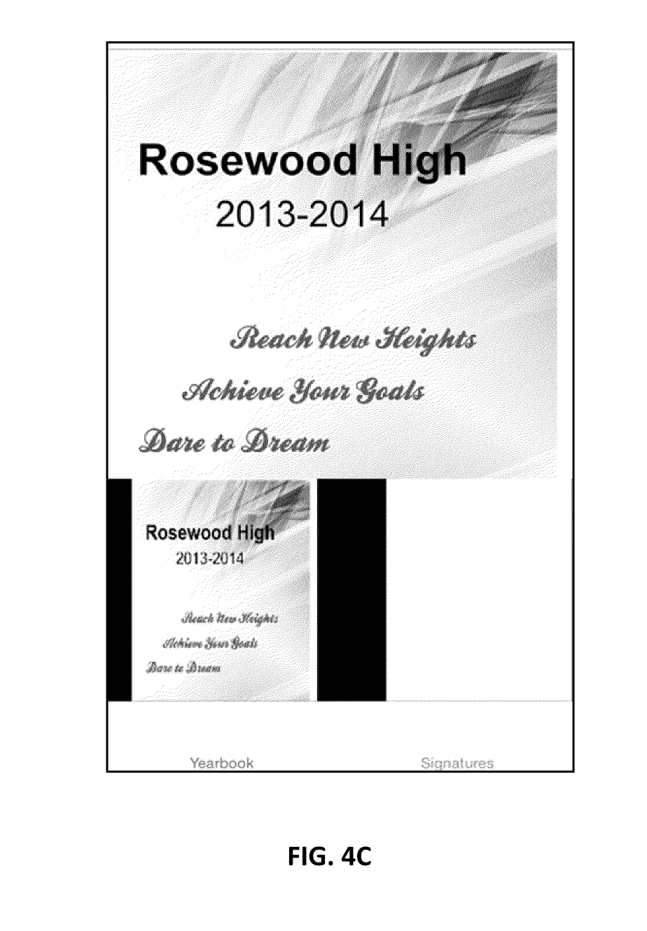

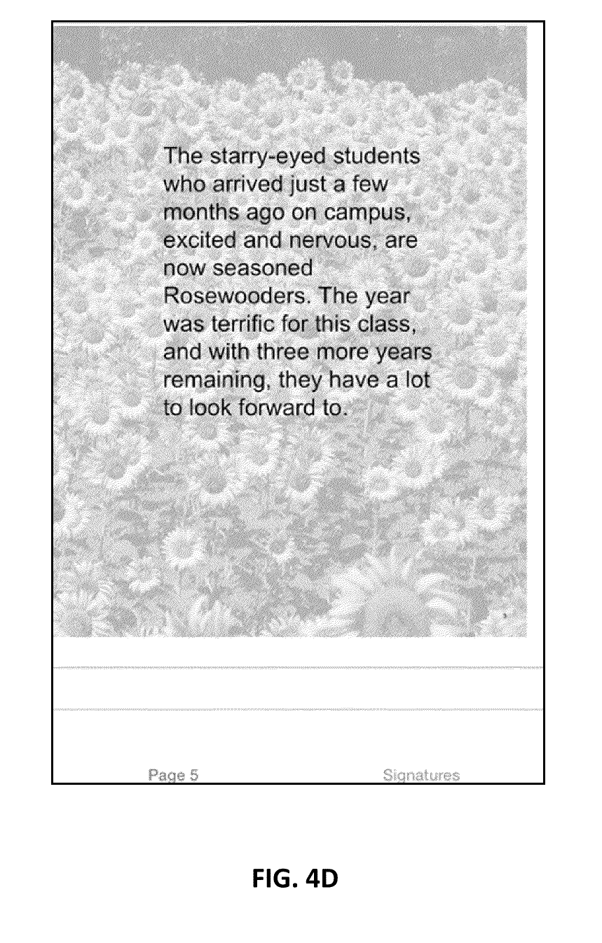

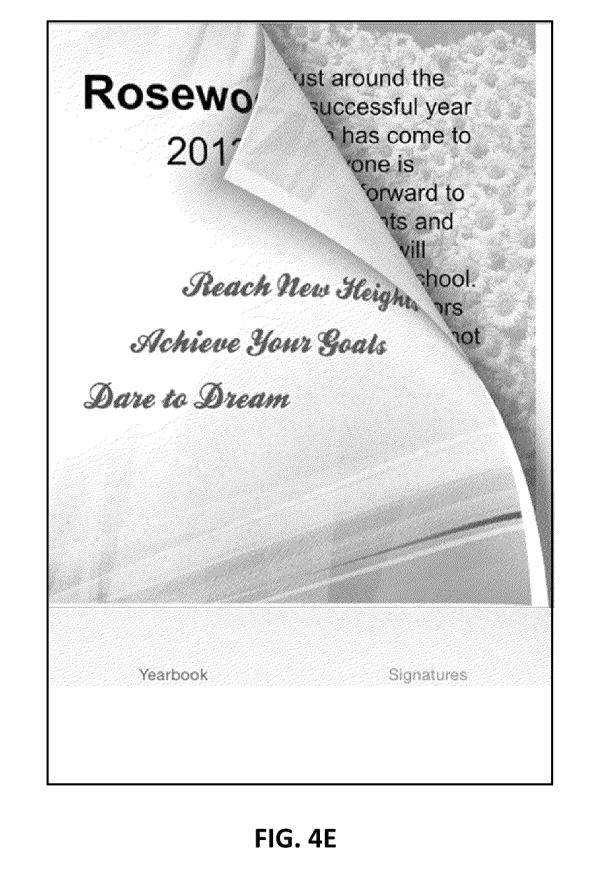

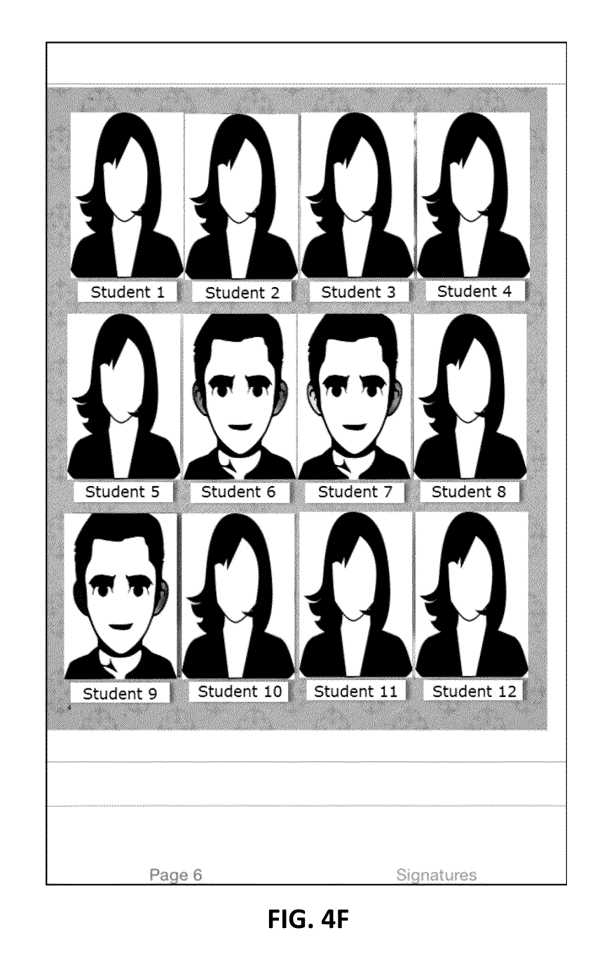

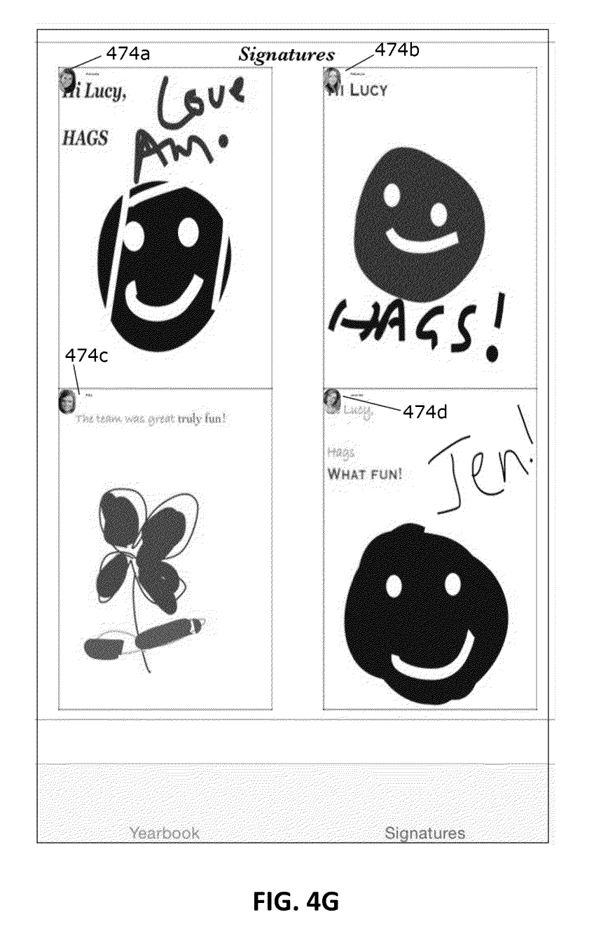

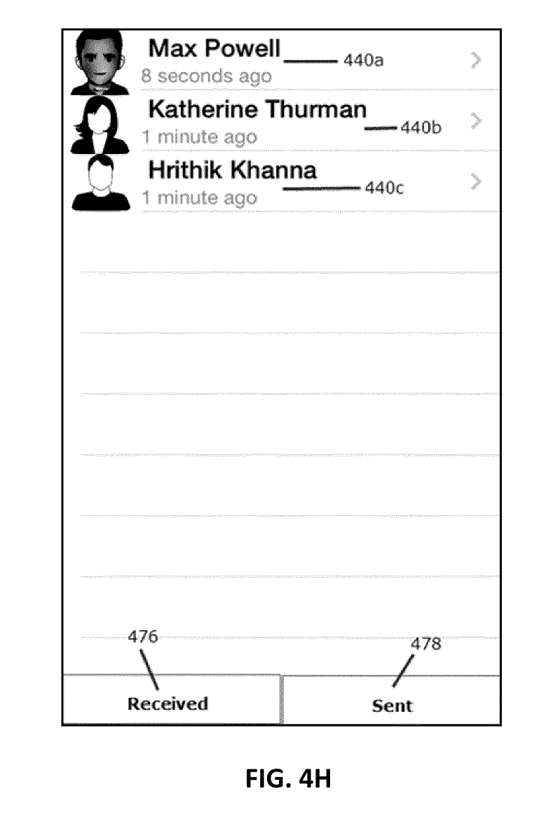

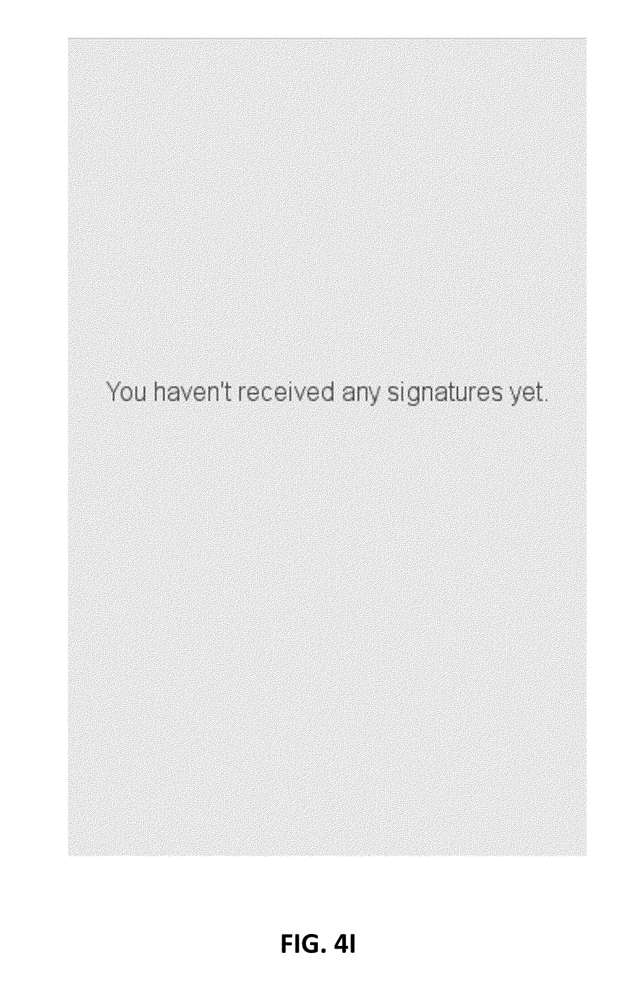

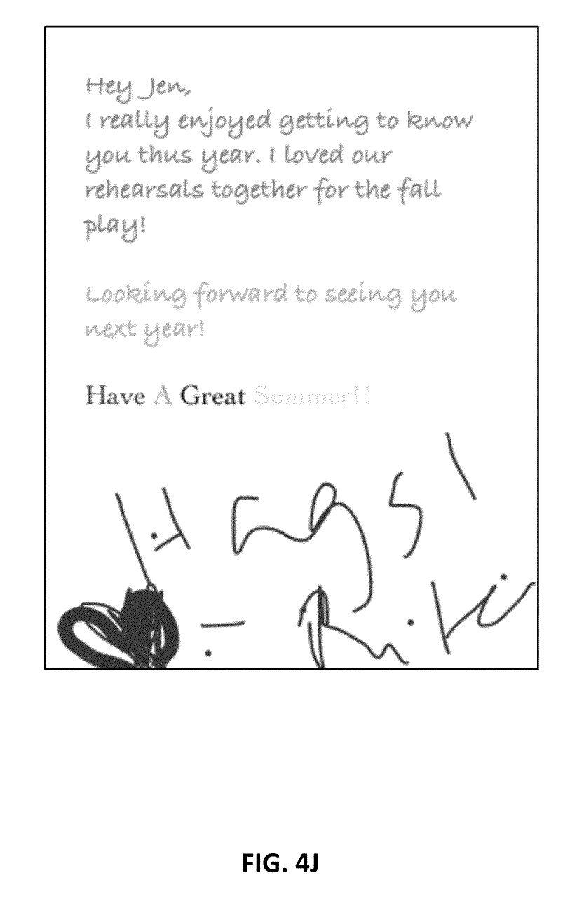

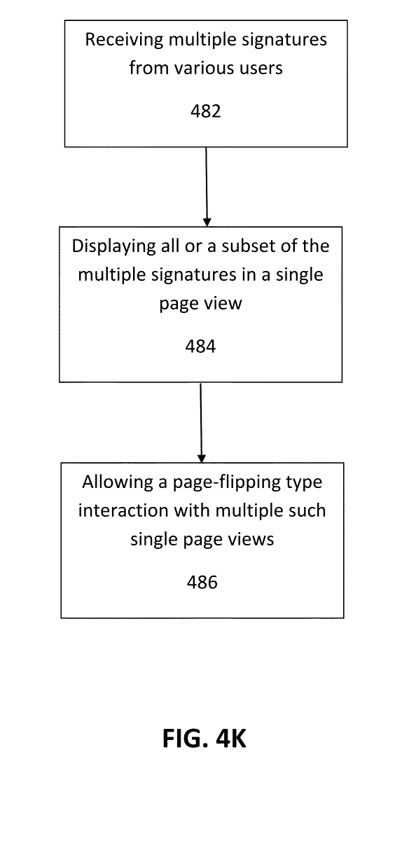

In accordance with one example embodiment, a book, brochure or other compilation relates to people and/or events within a certain group. For instance, it is common for a yearbook to include photographs of students in the school or college (or in certain grades in the school or college), as well as possibly photographs of the staff, various events that have taken place through the school year, and so on. In addition, there is often some information/description accompanying many of these pictures. In accordance with one example embodiment, some portions or all of a yearbook (310) can be viewed in an electronic format. See FIG. 4A. This format may be, for instance, pdf, jpg, png, gif, EPUB, eReader, and so on. In one embodiment, other technologies (such as QR codes etc.) are integrated.

In one embodiment, some custom pages specific to the student are part of the student's yearbook. These pages may include information about, or photos relevant to, the particular student whose yearbook it is.

In accordance with one example embodiment, signatures are obtained from other group members. In one embodiment, these signatures are obtained electronically, as described below.

In one embodiment, the signatures are viewable in a separate portion from the static portion of the yearbook. In FIG. 4B, it can be seen that there are different tabs, one (450) for viewing the static portion of the yearbook, and another (460) for viewing the signatures. Another tab (470) includes a video portion. This is discussed in further detail below. In one embodiment, some or all of these separate tabs may not be present. For example, the separate tab for viewing the signatures (460) is not present in accordance with an embodiment. Instead, signature pages are appended to the end of the yearbook so that the user perceives this as signature pages that are part of his or her book.

FIGS. 4C, 4D, 4E and 4F show various views of the yearbook, with various features such as thumbnails of pages that appear for easy scrolling, page-flipping like user interactions, and so on. In some Figures avatars have been used to depict photographs of various users, and it is to be noted that the same avatars may have been used to depict several different users.

In one embodiment, separate signatures are combined in a single view (e.g., in a single page), as shown in FIG. 4G. In one embodiment, these separate signatures are from different users. In one embodiment, these signatures can also be from the same user, but prepared as separate signatures. For instance, in one scenario the same user may sign a student's yearbook twice, maybe at different times.

In one embodiment, the number and/or placement of these multiple signatures in a single view is predetermined. For instance, as shown in FIG. 4G, in one embodiment 4 separate signatures can be placed on a single page for viewing. In another embodiment, 6 separate signatures are placed on a single page for viewing. In one embodiment, the number of signatures displayed on a single page is determined by the users in their preferences. In one embodiment, there are predetermined slots on a viewing page, which are filled in a certain order. For instance, the slots may be filled starting with the top left slot, proceeding across the top row, and then moving on to the next row when the first row is filled, and so on. In one embodiment, the user who is receiving the signatures can place each signature in any of the predetermined slots. In one embodiment, there are no predetermined slots. In one embodiment, the user who is receiving the signatures can place each signature anywhere on any viewing page. In one embodiment, the user who is receiving the signatures can manipulate the properties of the signature being placed. Such properties can include, but are not limited to, size, orientation, angle of rotation, and so on. In one embodiment, the user can customize the viewing pages further, for example by adding a background image to the page, borders to the page or to each signature slot, and so on. In one embodiment, a user can set preferences to determine whether the signatures will be automatically populated onto the signature view pages (e.g., using predetermined slots as discussed above), or whether the user will place the signatures on the signature view pages. The user may also be able to specify how many signatures should be placed on each page.

In one embodiment, identifying information shows (e.g., with a thumbnail photo maybe on the top left of each signature, with a name, etc.) who has signed each signature. It can be seen in FIG. 4G that in the combined view, identifiers (474a, . . . 474d) are present showing who had sent each signature. The identifiers (474a, . . . , 474d) can include, but are not limited to, the name of the signing user, the photograph of the signing user, both the name and the photograph, or any other identifiers. It is noted, and as is illustrated in FIG. 4G, that the received messages that are displayed may be one or more free-form message (e.g., text and images) entered in the sending user's device. Hence the receiving user receives in his/her their view specifically what was entered in the senders view. In one embodiment each the free-form message is embodied as a captured image that is transmitted back to the requestor.

By way of example, each free-from message is captured as an image (for example as a screenshot) from the sender's device, which is then uploaded to a remote server, and then downloaded onto the requesting user's device. As show in FIG. 4G, and as discussed above, multiple of these captured free-form message images can be combined into a single composite view on the requesting user's device. In one embodiment, only the requesting user can see such a composite view comprising of several free-form messages received in response to his or her requests. In one embodiment, the requesting user can reorder the composite view pages in his or her book, so that a certain page with multiple signatures on it is viewed before or after one or more other page views with multiple signatures on it. In one embodiment, a user can reorder any of the other pages in the book as well.

In one embodiment, the signature pages can also be flipped, navigated via thumbnails etc., similar to that shown in FIGS. 4C-4F. For example, flipping a page may include the rendering of the user interface to gradually remove one page from view from a side or corner of the user interface and introduce into view a new page from that same side or corner where the prior page is disappearing from view.

In one embodiment, the signatures are depicted as part of the yearbook, and the entire yearbook, including the signatures, is viewable as a whole. In one embodiment, the entire yearbook is viewable in multiple portions.

In accordance with one embodiment, these signatures can be viewed completely separately from the static portion of the yearbook by the user. For example, clicking on “View signatures” (320) in FIG. 3A can take a user to a user interface shown in FIG. 4H. If there are no signatures received yet, such a notification may be provided, as seen in FIG. 4I. Clicking on a specific entry such as 440a, 440b or 440c, takes the user to view the single signature from the corresponding user. An example of a single signature view can be seen in FIG. 4J.

It can be seen in FIG. 4H that signatures received (476) by a user as well as signatures that have been sent (478) by the user can be viewed in accordance with an embodiment of the present invention. Just like specific entries of signatures received 440a, 440b, and 440c are visible in when the tab corresponding to signatures received (476) is selected, specific entries of signatures sent are visible when the tab corresponding to signatures sent (478) is selected.

FIG. 4K shows a computer-implemented method and/or user interface in accordance with an example embodiment. Multiple signatures from various users are received (step 482), and all or a subset of these are displayed (step 484) on a single page view. In one embodiment, a book-like compendium of the pages is created, with each page having multiple signatures from multiple users, and a page-flipping type interaction with these page views is allowed (step 486).

In one embodiment, the custom pages mentioned above, if existing, are viewable separately from the rest of the yearbook. In one example embodiment, these custom pages are integrated along with other portions of the yearbook.

In one embodiment, the yearbook is divided into separate sections which are viewable separately. Examples of these are student portraits, school events, custom pages for a student, signature pages, and so on. In one embodiment, a separate video portion (470) or video supplement may be included as a section of the yearbook, as can be seen in FIG. 4B. Such a section may be integrated into, or be separate from, other sections of the yearbook. For instance, a video portion (470) may include videos of certain events from the school year, certain games, performances, etc. In one embodiment, it is possible for signatures to be split up into different sections as well. For instance, signatures from students in a certain grade, or students in a certain club etc. may form separate sections, signatures from teachers may form a separate section, and so on. A user may be able to set up these different sections in his or her preferences. In one embodiment some or all of these sections are combined, and are viewable as a whole.

In one embodiment, some portions of, or all of a user's yearbook, are not viewable by other users. For instance, in one embodiment, the signatures a user receives are private and can be seen only by the user receiving them, and by the user who has signed them. In one embodiment, the signatures received by a user and/or some portions of the user's yearbook are viewable by subgroups of students, which the user receiving the signatures can create or define based on certain parameters. For instance, a student may choose to let all the students in his class see the signatures he or she has received. In one embodiment, a student may choose to let a subgroup of students see his or her entire yearbook. The subgroup may be enlarged to include all the members of the group.

In one embodiment, a user receiving the signatures can choose to share one or more signatures, and/or different portions of his or her yearbook, by using social media or mobile applications. In one embodiment, a user signing is allowed to implement such features. For instance, a user may post such information on his or her FACEBOOK, TWITTER, GOOGLE PLUS and/or YOUTUBE accounts. Other examples of sharing modalities can include, but are not limited to, other mobile apps such as SNAPCHAT, WHATSAPP, etc. It is to be understood that these are merely examples of ways in which a user can share such information. Such sharing features are seamlessly integrated.

In one embodiment, described in more detail below, the entire yearbook maybe dynamically modifiable, and maybe viewable as a whole. In one embodiment, the entire yearbook is dynamically modifiable, but is viewable in multiple portions (for example, a portion showing the student portrait section, a portion showing school events, and a portion showing signatures received).

In one embodiment, the pages of the yearbook (including the signature pages) can be scrolled through or flipped through, resembling the reading of a paper book. In one embodiment, easy navigation can be aided by features such as thumbnails of the different pages

### Requesting Signatures

In accordance with an example embodiment, a member of the group (for instance, a student) can electronically request another member of the group to sign his or her yearbook. It is to be noted that a signature here is not limited to formal autographs, but also includes anything that one group member might want to convey to another. When a signature is requested of one group member by another group member, a signature in response to such a signature request may include several forms such as, but not limited to, an actual signature, hand-written or free-form messages and/or doodles, typed text, pre-designed or custom-designed stamps, stickers, one or more images/photographs, one or more videos, one or more audio files, and so on.

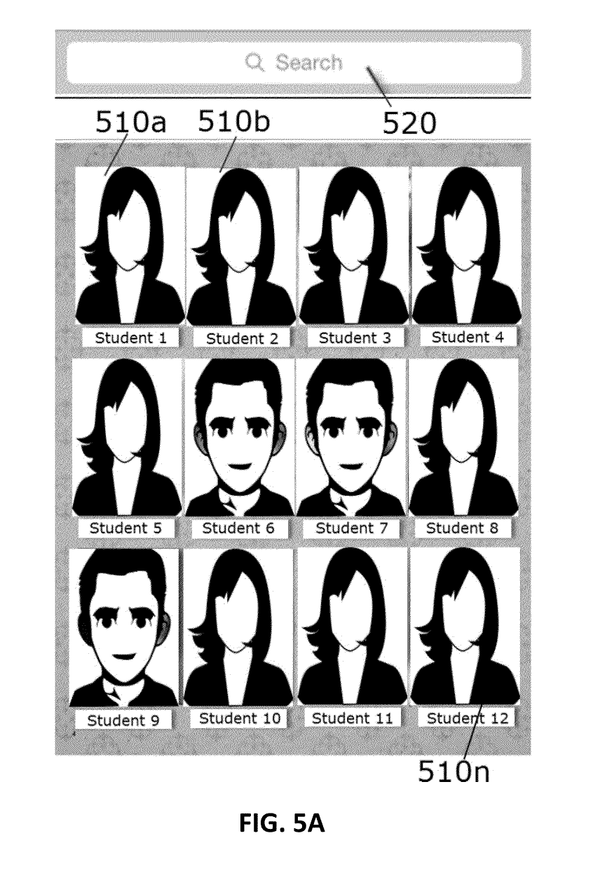

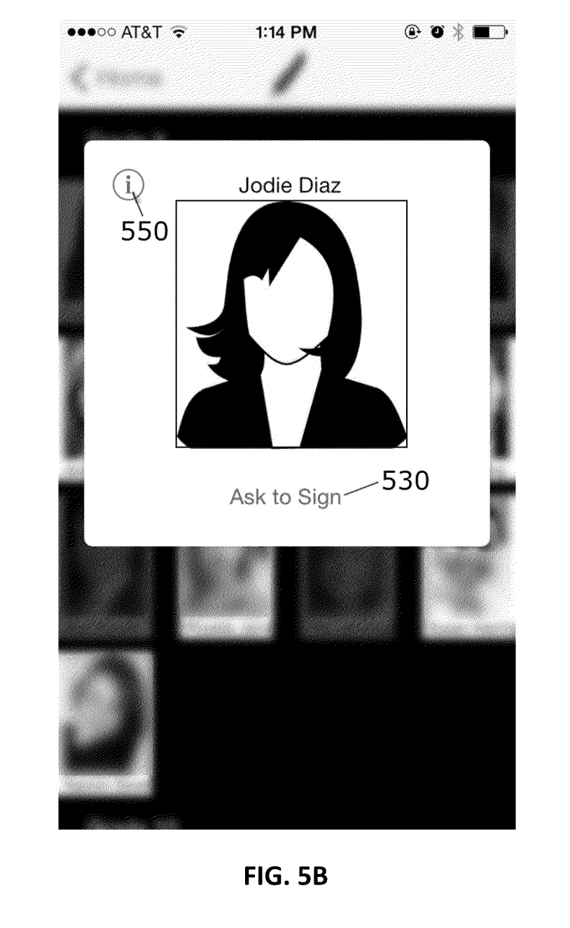

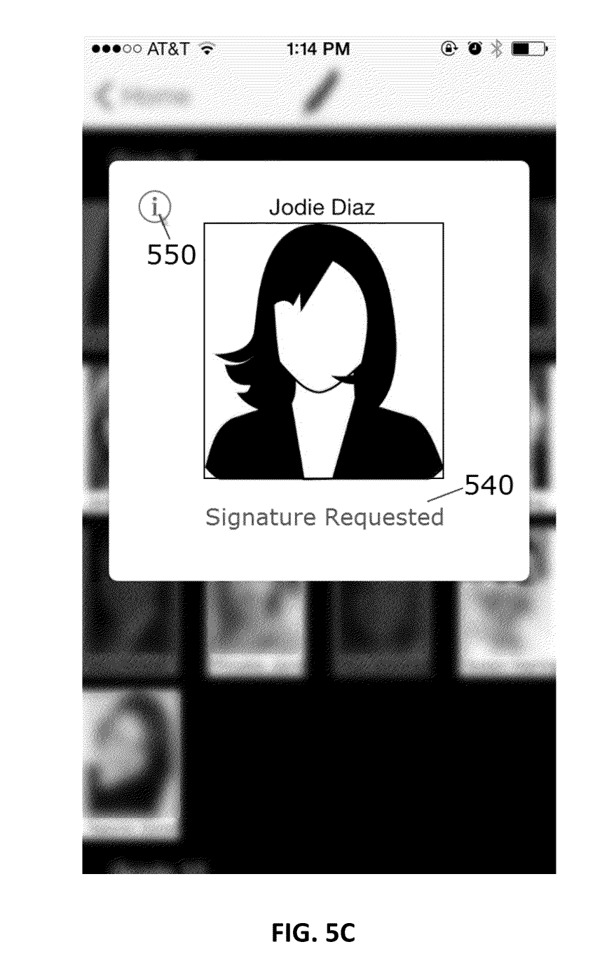

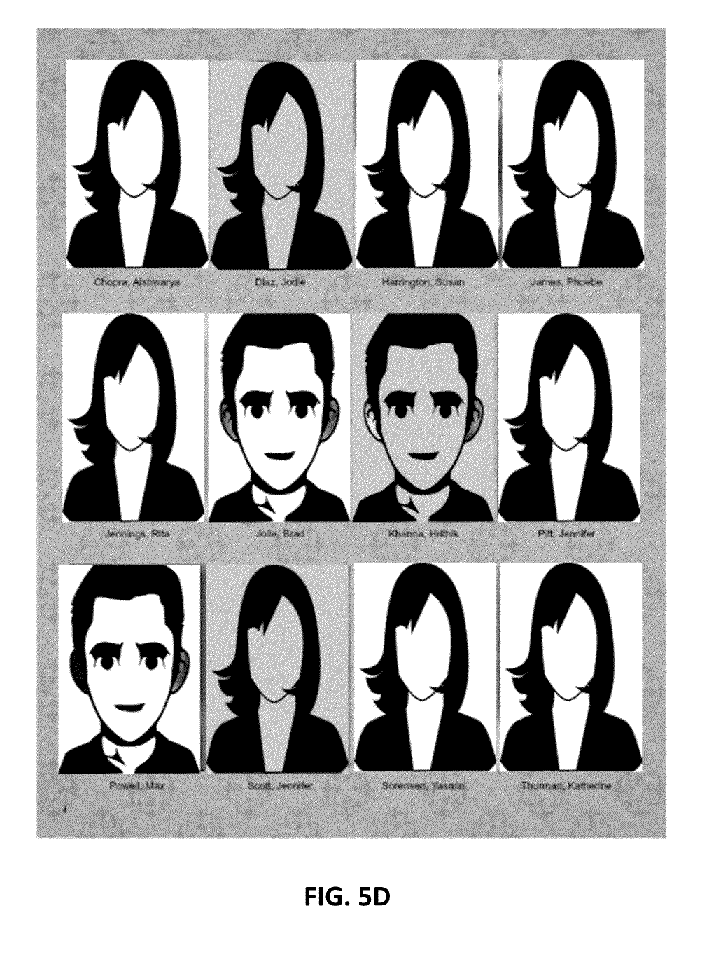

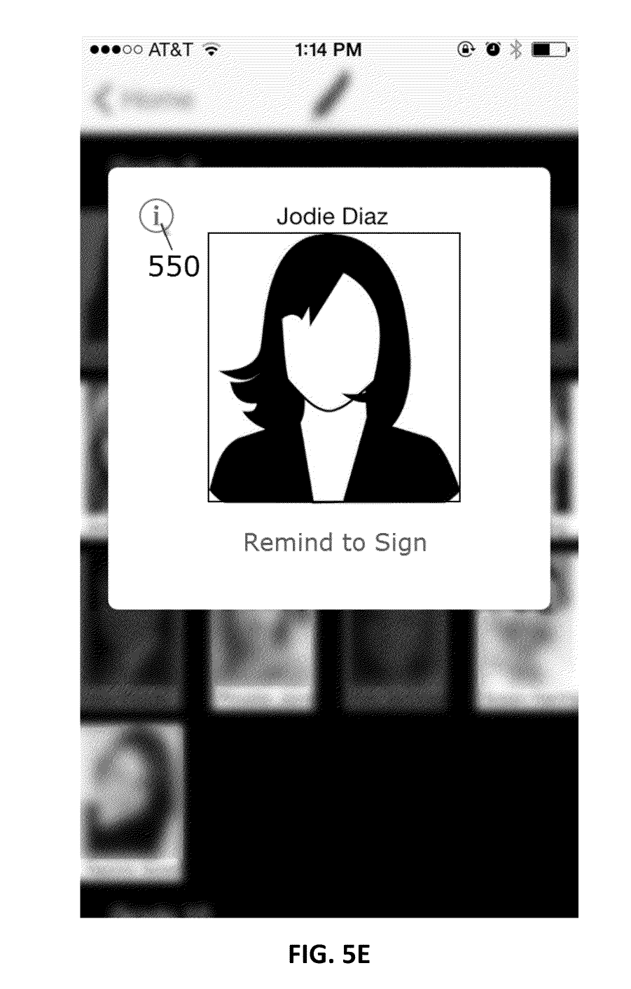

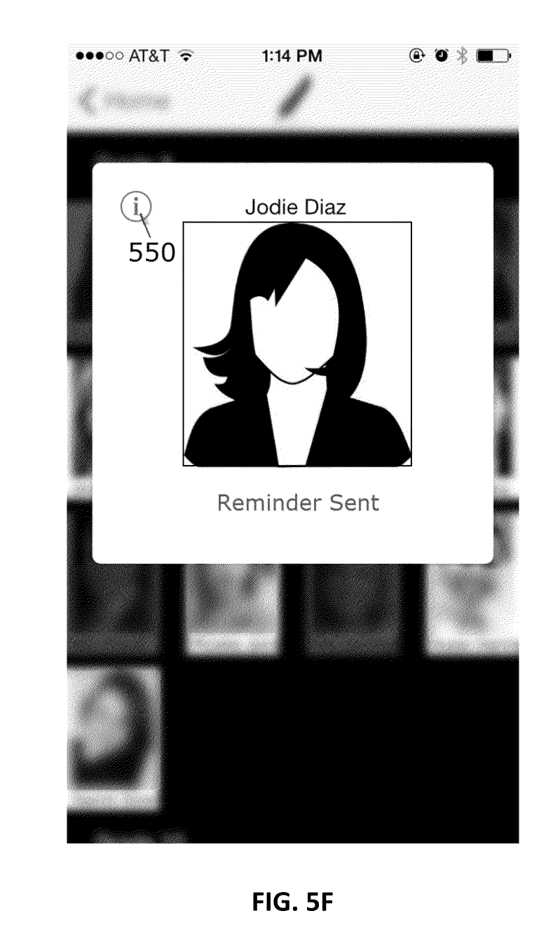

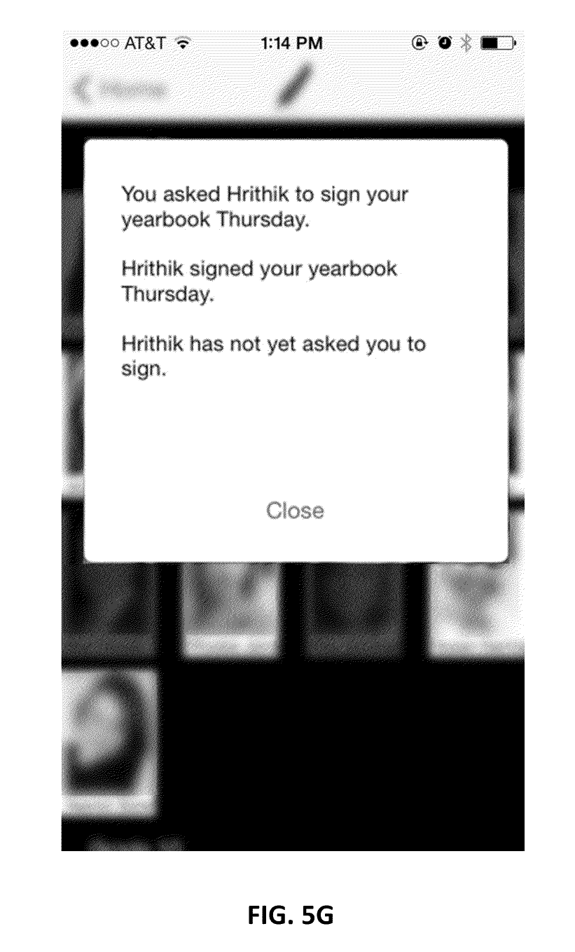

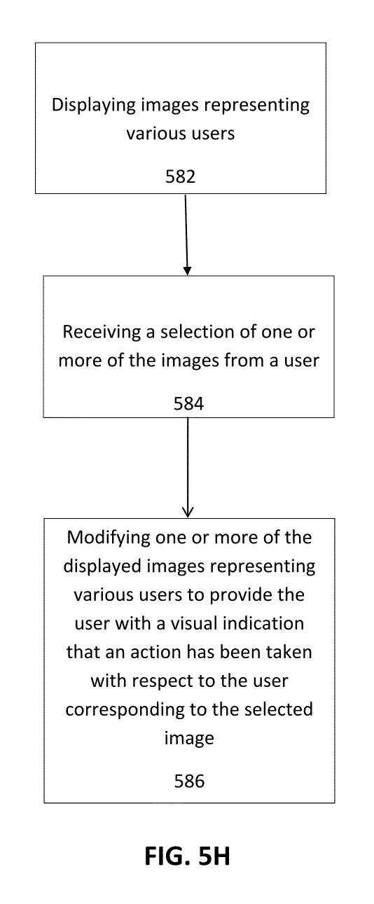

Referring to FIG. 5A, it can be seen that in one embodiment, photographs (510a, 510b, . . . , 510n) of the members of a group can be seen by a user. (Some photos have been blurred to prevent identification herein.) In one embodiment, these photos can be sorted in different manners (e.g., by grade, by last name, by first name, by home room, and so on). In one embodiment, there are tags associated with users, and photos can be sorted based on tags as well. Some examples of tags are clubs that a student belongs to, activities that a student is interested in, and so on. In one embodiment, these tags are created by users. In one embodiment, these tags are created automatically based on information in a profile associated with each user/student. In one embodiment, some tags are created automatically, while some can be created by users. In one embodiment, a search or filtering (520) functionality is available, wherein a user can specifically search for a specific person by name, or look for students only belonging to a certain grade, having a certain tag, etc.

In one embodiment, a hand-drawn sketch, an avatar of some kind, or a placeholder (e.g., a school mascot) is used for some or all of the students instead of the student's photograph.

In a user interface in accordance with one example embodiment, a signature is requested from another user by interacting with (such as by tapping on) the photograph of the person whose signature is desired. In one embodiment a request for signature is sent to the person in the photograph when his or her photograph is tapped. In one embodiment, the photograph of the student that is tapped upon is enlarged, and a “Ask to Sign” (530) option is shown. This can be seen in FIG. 5B. When the user taps on this option, a signature request is sent to the student. As can be seen in FIG. 5C, the “Ask to Sign” is replaced by “Signature Request Sent” (540). In accordance with an embodiment of the present invention, other updated information/statuses can be indicated. Examples of such statuses include “Remind to Sign”, “Signature Received” and so on.

In one embodiment, once a request for a signature has been sent to a particular student, the user is provided with some feedback, which could be visual feedback. Refer to FIG. 5D for instance, where photographs of some students are grayed out, indicating that signatures have already been requested from them. In one embodiment, signature requests can be resent, or reminders to sign sent, by clicking on a photo of a student to whom a signature request has already been sent, as shown in FIGS. 5E and 5F. In other embodiments, other triggers for feedback may exist, such as when a signature has been received from a particular user, or when a signature request has been received from a particular user, and so on. Also, other types of feedback may exist, such as color changes, glowing, etc., as well as non-visual types of feedback such as vibrations, auditory feedback, etc.

In one embodiment, additional information relating to a student can be obtained, as shown in FIG. 5G, which is accessed by selecting the “i” (550) in FIG. 5B. This information can include, but is not limited to, whether a signature has been requested from the student in the photo, and if so when, whether the student in the photo has requested a signature from the user, if so when, and so on. In one embodiment, such information provides an update summary of interactions between the user and the student in the photograph.

In one embodiment, the signature requesting module (160) is a part of the yearbook viewing module (150) described above. For instance, the photographs (or any other representations) of the students (510a, 510b, . . . , 510n) can be interacted with by a member/user, from the same user interface where the member/user is viewing the yearbook. In one embodiment, the section of the yearbook with the photographs of the students will not be static, as the photographs of the students change appearance or provide some indication of which students signatures have been requested from, as discussed above.

In one embodiment, the signature requesting module (160) is a separate module, and the photographs of the students (510a, 510b, . . . . , 510n) can be viewed in a separate area, such as from the “Ask” (340) option shown in FIG. 3A. In one embodiment, when the user selects the “Ask” (340) option, he or she is shown a screen such as that shown in FIG. 5A.

In one embodiment, the requests for signature are sent within a mobile application itself. In one embodiment, the requests for signatures are sent using other forms of communication such as an email, a text message, an SMS, an MMS, etc.

As mentioned above, the signature requesting module (160) can exist by itself in the absence of the viewing module (150), and/or the signing module (170). In one embodiment, the signature requesting user interface as shown in FIG. 5A provides an easy to use, intuitive and visual user interface for communicating with one or more of a group of users.

In one embodiment signatures from multiple users can be requested simultaneously. For instance, in one embodiment, a user can select multiple users by, for instance, clicking on multiple photos (refer to FIG. 5A), and send a signature request to all the users corresponding to the selected photos. In one embodiment, a “select all” functionality is available to select the photos of all the users in the group. In one embodiment, a “select all” functionality is available to select all the photos that have been selected out by the current filter (520) applied. In one embodiment, a visual indicator (e.g., a check mark on the photo, a graying out of the photo, etc.) shows which photos have been selected for sending out the batch signature request.

In one embodiment, a user is able to send an SMS/text message or email to another user from within the app. For example, when a user sends a signature request to another user, the requestor may also send a text message stating that he or she has requested a signature. This is particularly helpful if the person whose signature is being requested has not downloaded or is not using the app, or has turned off notifications for the app. Such a text or email may already be pre-populated.

FIG. 5H shows a computer-implemented method and/or user interface in accordance with an example embodiment. Images representing various users are displayed (step 582). A selection is received (step 584) from a user of one or more of the images. The user may perform this selection, for instance, by tapping on one or more of the displayed images. The display of the various images is then modified (step 586) to indicate that a certain action has been taken. For example, the action may be sending a signature request to the user(s) corresponding to the selected image(s), and the modification of the images may be graying out or fading out the images as shown in FIG. 5D.

### Signing Yearbooks

In one embodiment, a user cannot proactively sign another user's yearbook, but rather can only sign it if he or she has received a request to sign that person's yearbook. In one embodiment, a user can request that another user send him or her a signature request. In one embodiment, a user can proactively sign another user's yearbook.

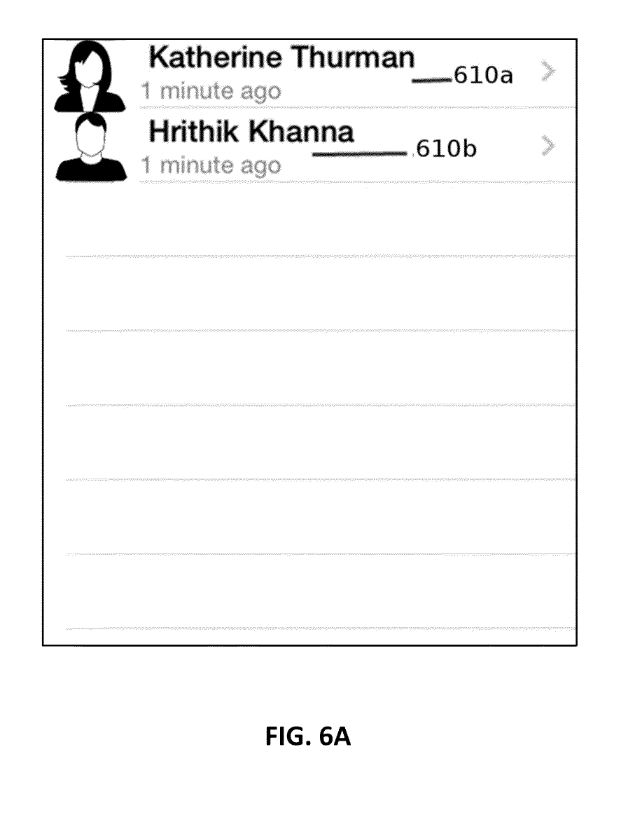

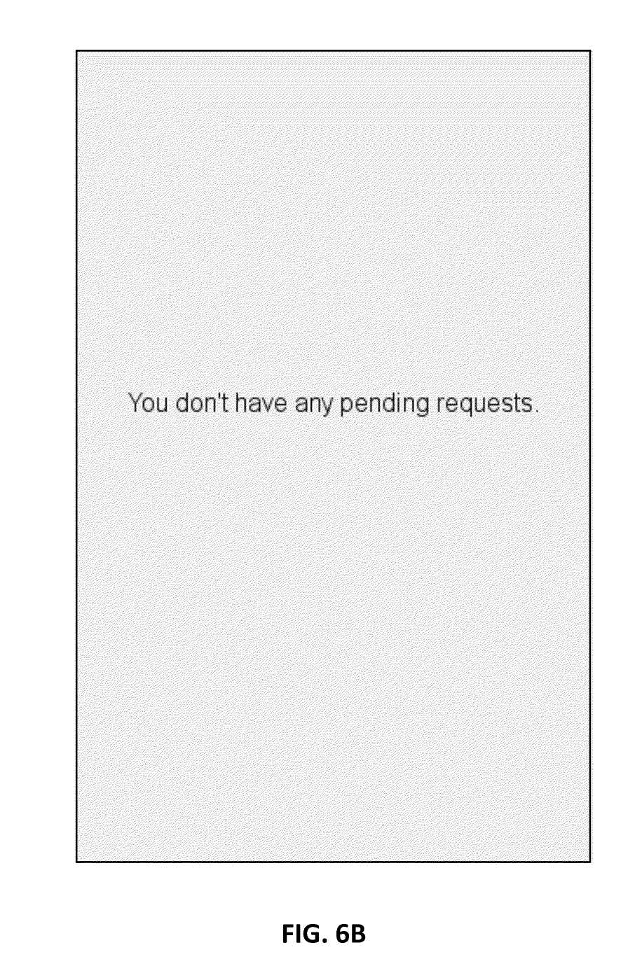

In one embodiment, when a user sends another user a request for a signature as discussed above, the user to whom the signature request has been sent can see it by choosing the “Sign” (330) option in FIG. 3A. In one embodiment, the user will see the various signature requests received that are pending (that is, requests that the user has not yet responded to by signing in response) as is illustrated, for example, with FIG. 6A. Related information can be displayed which includes, but is not limited to, who the signature request is from, how long ago the request was sent, and so on. If no signature requests have been received, such a notification may be provided, as shown in FIG. 6B.

In one embodiment, the user receiving the signature request can respond by signing immediately. In one embodiment, the user receiving the signature request has other options available. For instance, he or she can choose to ignore the signature request, choose to sign later, and so on. In one embodiment, if the user chooses to sign later (may be done using a “remind me later” option), the user gets a reminder to sign at a later time (such as a day or two days). The time interval for the reminder(s) may be set by the user as preference.

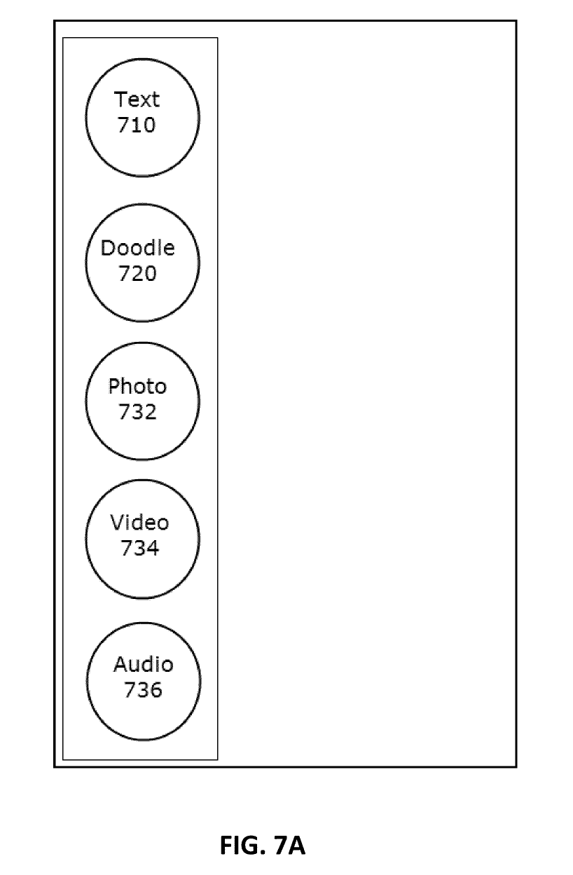

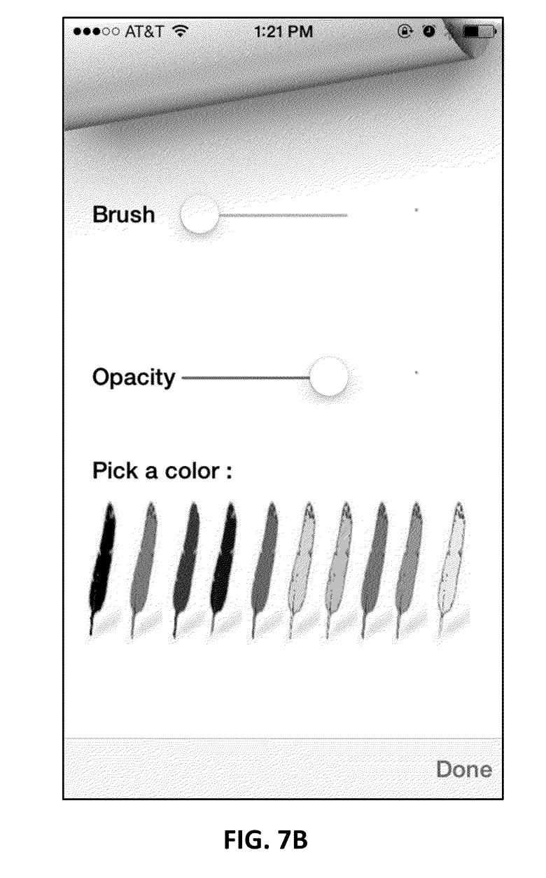

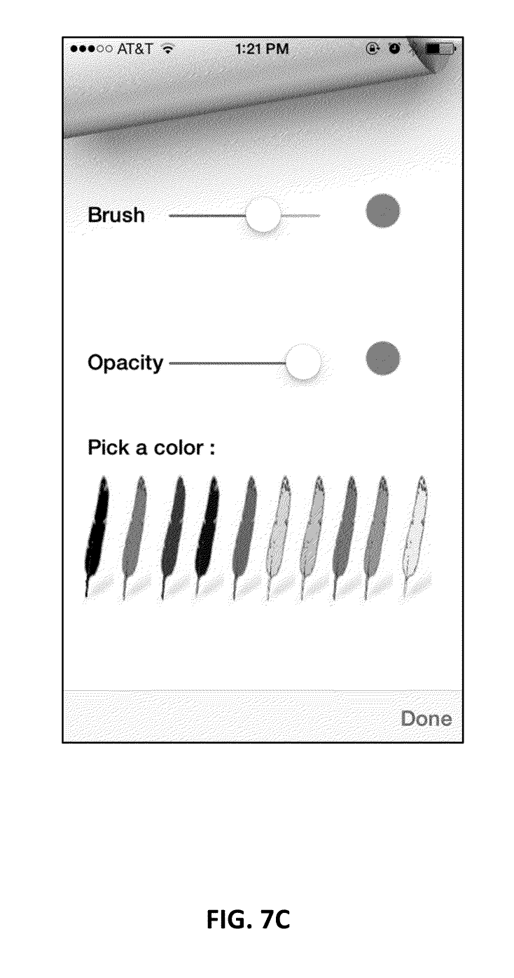

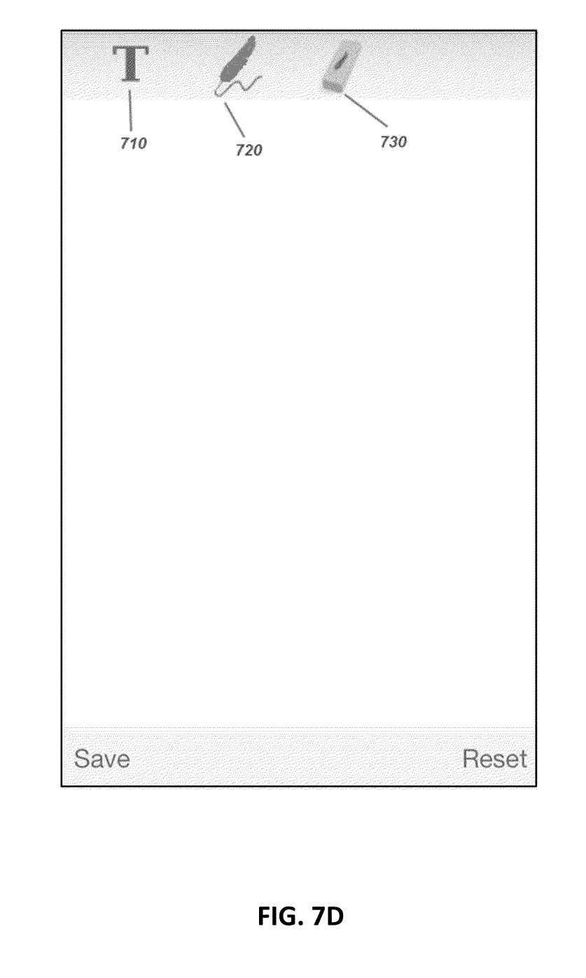

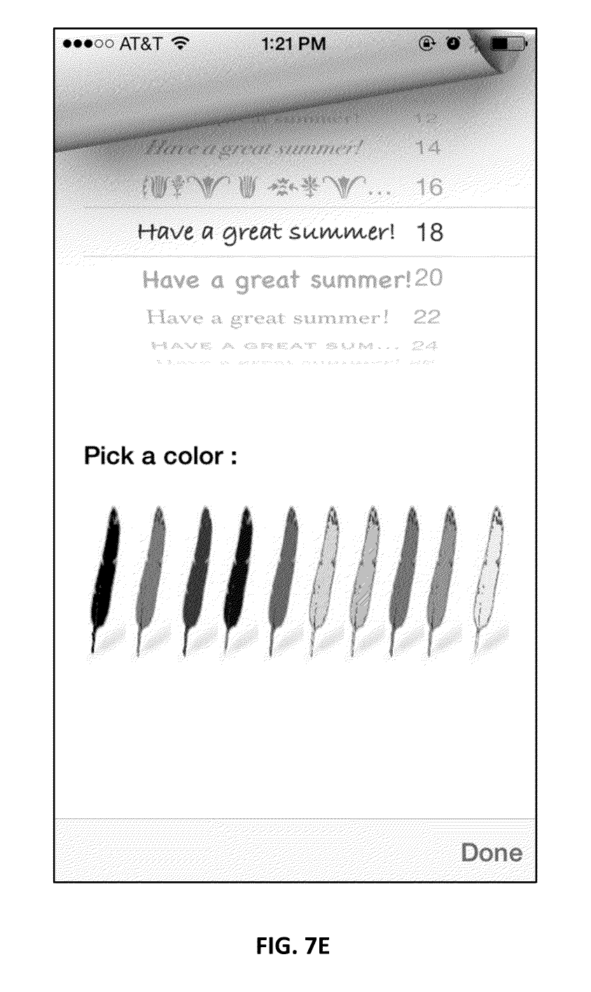

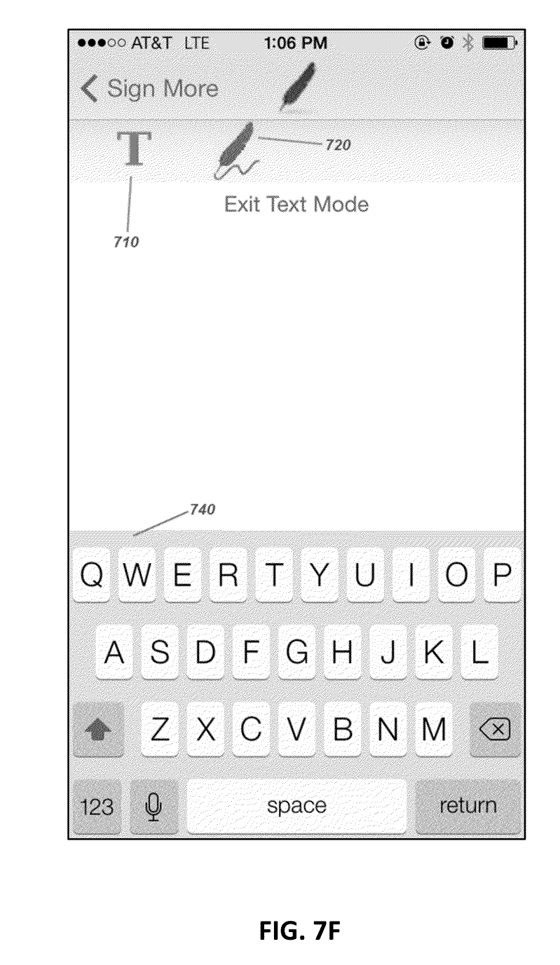

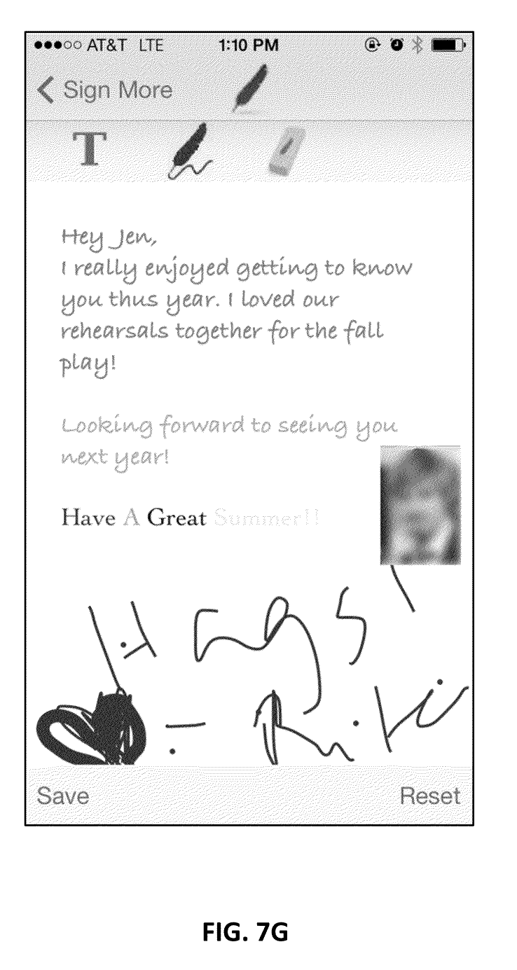

When the user chooses one particular signature request (such as 610a, 610b, etc.), in one embodiment, he or she is presented with a blank screen on which to create the signature, as shown in FIG. 7A. In one embodiment, the user can create a signature using various modalities. Example of such input modalities include but are not limited to typed text (710), hand-written or free-form messages and/or doodles (720), photos (732), videos (734), audio (736). Examples of other things that could be included in the signatures include pre-designed or custom-designed stamps, stickers, and so on.

In one embodiment, one of these options is selected by default, and in one embodiment, the user can select the default option in his or her preferences. The default option shown in FIG. 7A is the typing option (710). One or more of these options can be free, while other may require a payment, a subscription, etc. In one embodiment, the user can choose certain options based on which input modality he or she is using. For instance, as shown in FIG. 7B and FIG. 7C, when the doodling free-hand modality (720) is selected, in one embodiment the user is able to select the color to be used and the size of the stroke as well as its opacity. It can be seen in FIG. 7D that, in one embodiment, when a specific color is picked in the free-form options, the icon for the free-form messages (720) changes to that color to provide the user with visual feedback about the color that is currently selected.

An eraser option (730) is also available in one embodiment. As another example, when the typing modality (710) is selected, in one embodiment the user is able to select a font, a font size, and the color of the typing, as shown in FIG. 7E. Upon clicking on the blank signature page when in the typing modality (710), a keyboard (740) appears as shown in FIG. 7F. It can also be seen in FIG. 7F, that the color of the icon representing the typing modality (710) changes to the color of the font selected, so as to provide the user with appropriate information about the currently selected font color. It is to be noted that some of these options are only visible when particular input modalities are selected. For instance, in one embodiment, the eraser option (730) is not visible when the typing modality (710) is selected, but is visible when the free-form input modality (720) is selected.

In one embodiment, a user can combine various input modalities in a single signature. For instance, as shown in FIG. 7G, a single signature can include some typing, some free-hand drawing and writing, and a photo.

In one example embodiment, signatures/annotations can be created on pre-printed or pre-prepared material. This pre-prepared material can be in any format, such as pdf, jpg, ePub, etc. An example of this is the section of the yearbook including student photos and/or school events. While in some embodiments these portions of the yearbook are static and cannot be modified by the users, in some embodiments, these portions of the yearbook are dynamic and can be modified by the users. For instance, users may be able to paste stickers on, put stamps on, or type or free-form doodle/write on photos and/or pages with photos. A fun example of this is sticking or drawing a mustache, cap, glasses or sunglasses on a student photo.

When the user has completed the signature, he or she will indicate this to the mobile app in accordance with an embodiment of the present invention, by selecting, for instance a “Done” or “Save” button, as can be seen in FIG. 7A. In one embodiment, the user will then be returned to the list of remaining pending signature requests, if any. In one embodiment, the signature request to which the user just responded is no longer visible in the list, since it is no longer pending. If no requests are pending, in one embodiment the user will see a screen as shown in FIG. 6B.

In one embodiment, the student signing a student's yearbook in response to a signature request is provided with feedback that his or her signature has been recorded. For instance, when a signature is saved using the “Save” button shown in FIG. 7A, a message could be shown to the user, stating something like “Thank you for signing XYZ's (where XYZ is the name of the student requesting the signature) yearbook.” In one embodiment, the message could provide some further information such as “You will be notified when XYZ views the signature you have created.” In one embodiment, when the student who had requested the signature views the signature, the student who has signed is notified of this event.

In one embodiment, the student who requested the signature is notified when he or she receives a signature.

In one embodiment, the student receiving the signature can respond to the signature in some way. For instance, he or she can comment on the signature. Like the signature itself, in one embodiment such a comment can be in any form such as, but not limited to, typed text, freeform writing/doodling, stickers, stamps, images, video and/or audio, or any combination thereof. For instance, an audio message may be sent to the user who created the signature, saying something like “Thanks a lot ABC (the signature sender's name). Your signature was awesome!” As another example, a “thank you” or flower sticker or stamp can be sent. In one embodiment, in addition to or instead of a comment, a simple “Like”, “Thumbs Up”, “Yo” or star type ratings (e.g., using a number of quill icons as a rating) can be given to the signature. In one embodiment users can create or select automated messages to be sent or actions to be taken when a signature is received.

In one embodiment, in addition to or instead of the signature itself, such comments/feedback may be shared with others. In one embodiment, such sharing can be by the student commenting, and/or by the student receiving the comment. In one embodiment, the people with whom such sharing can be done are limited to the members of the group. In one embodiment, the people with whom such sharing can be done are not limited to the members of the group.

In one embodiment, comments and or other indicators/ratings described above are given by the student receiving the signature. In one embodiment, such comments and or other indicators/ratings are given by other people as well, such as those with whom the signature has been shared.

As mentioned above in the context of signatures received, such comments and/or feedback may also be shared using social media (such as FACEBOOK, TWITTER, GOOGLE PLUS, YOUTUBE, and so on) and/or other mobile applications (such as SNAPCHAT, WHATSAPP, and so on). It is to be noted that such sharing is integrated into and can be done from within a mobile application in accordance with an embodiment of the present invention.

In one embodiment, the user receiving the signature has the ability to approve, reject and/or moderate the signature. In one embodiment, a moderator or administrator can moderate, approve, or reject signatures. In one embodiment, only after a signature has been approved does it show up in the receiving user's yearbook. In one embodiment, a received signature which has already been placed in the yearbook can be deleted by the student whose yearbook it is. In one embodiment, a received signature which has already been placed in the yearbook can be deleted by a moderator or administrator. In one embodiment, the user receiving the signature can delete the signature. In one embodiment, a signature that is deleted is removed from both the single signature view (FIG. 4J, which can be accessed via FIG. 4H) and the combined signature view (FIG. 4G). In one embodiment, a signature that is deleted by the user is deleted from the combined signature view alone or from the single signature view alone. In one embodiment, when a signature is deleted, the signature is also deleted from the signator's sent signatures view (474). In one embodiment, when a user (either the signator or the recipient) tries to access a deleted signature, the user is informed that the signature is no longer accessible.

In one embodiment, there is a specific time window within which a book can be signed and/or otherwise dynamically modified. For example, a yearbook for a certain year is only opened for modification and/or viewing say a month before school closes, and can only be modified until, say, two weeks after school closes. After this time window is closed, the yearbook is no longer dynamically modifiable. In one embodiment, the window is determined so that sufficient time is available for students to obtain all the signatures they would like.

In one embodiment, older yearbooks can be made available to the user only for viewing in the viewing module (150). In one embodiment, the older yearbooks are archived, and are not modifiable, but can only be viewed. As one example of such an embodiment, when a user selects “Yearbook” (310), he or she is presented with the current yearbook on top, and older yearbooks underneath, organized by year, and can select the one he/she wants. Only the current yearbook will be modifiable during the appropriate time window in accordance with an example embodiment, while the rest are only viewable. In one embodiment, the user has to subscribe in order to have his or her books archived. If archiving is not subscribed to by a user, his or her books may be deleted after the passage of a certain amount of time (for example 3 months, 6 months, a year etc.). If a user chooses not to archive, and/or chooses to delete his or her account, he may be provided with an option to download the yearbook onto his or her computer or cloud space (e.g., DROPBOX, GOOGLE DRIVE, and so on).

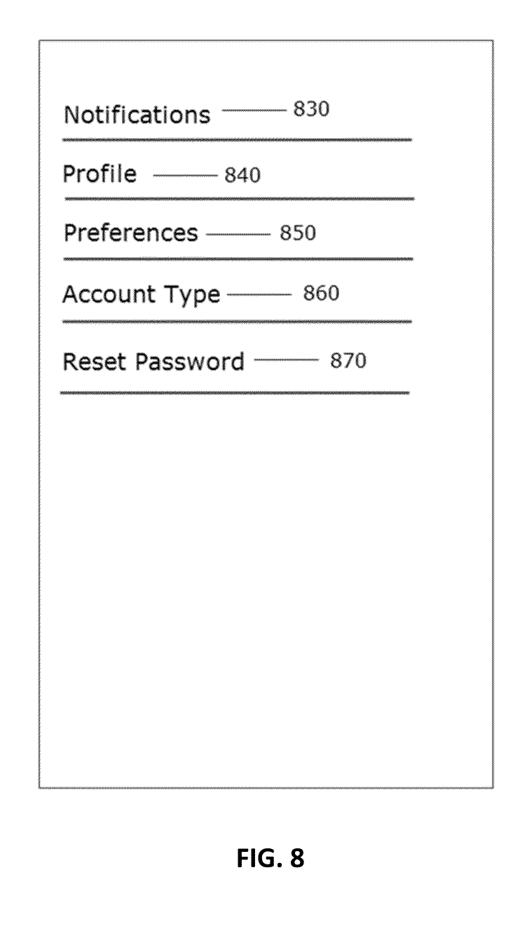

In one example embodiment, a user can also see and manage information about his or her account, his or her profile/preferences, and/or notifications. See FIG. 8 as an example. One or more of these sections may be combined in a single view, or they may be in separate views. There are many features and functionalities associated with such sections. For instance, the user may be able to change userid, password (870), and subscription level/type of account (e.g., free, paid, premium, etc.) (860) in the accounts management area. As another example the user may be able to create and manage a profile page (840), which can include some information about the user (e.g., more photos the user may want to include, interests and activities of the user, clubs that the user is a part of, home room, teachers, and so on). In one embodiment, tags referred to earlier herein are created based on information in the profile. Still another example is getting notifications (830) when certain events happened (such as receiving signatures, receiving comments on signatures, etc.). Yet another example is that a user can customize certain preferences (850), such as how many signatures to see in a single view, a standard message/comment to send when a signature is requested and/or received, what notifications to receive, and so on.

In one example embodiment, a different theme may be used in an app, based upon the type of group using the app, and/or the choice of the administrator or user. For instance, wedding themes may be used for use with wedding parties, sports themes may be used for sports clubs, graduation themes may be used for graduation books, school related themes may be used for yearbooks, and so on. In one embodiment, an administrator may have a choice of which theme to select. In one embodiment, the look and feel of the app will change based on the theme selected. The borders and backgrounds available, the stamps and stickers available, and even the icons/words used for various things like menu options, typing text, free-form doodling, color choices, etc. can change based on a chosen theme.

In one embodiment, there may be a range of backgrounds, borders, stickers, stamps etc. available within a single theme or within a set of themes relating to a certain topic (e.g., weddings, graduations, birthdays, and so on). Individual users can then select specific backgrounds, borders, stickers, stamps etc. for particular signatures they are receiving and/or creating. In one embodiment, there are no overall themes, but there are still different backgrounds, borders, stickers, stamps etc. which the individual users can choose when creating and/or receiving signatures. In one embodiment, a user can create different borders and/or backgrounds for viewing the dynamic portion of the compendium, such as the multiple signature page views. In one embodiment, a user can create different borders and/or backgrounds for viewing the static portion of the compendium, such as portraits of users, events pages and so on. In one embodiment, a user can create different borders and/or backgrounds for viewing both the static and dynamic portion of the compendium.

In one embodiment, the compendium may be a yearbook supplement. Such yearbook supplements may include materials that are not included in the yearbook itself, due to space or time constraints.

As stated above, while yearbooks and students have been referred to in several places herein, the embodiments of the present invention are in not limited in such ways. Examples of other instances include church groups, sports clubs, clubs within institutions (e.g., debate club), sports teams, book clubs, wedding parties, reunion books, and on. Corporations or companies, or a subgroup or a business unit of a corporation is another example. In the context of such a group, comments surrounding a farewell party for a colleague can be captured. In some embodiments, the group is created by a user/administrator. For instance, a group of wedding invitees may be created by the bride or bridegroom etc. Signatures/Guest comments etc. can be then be requested, obtained from such a group, and viewed.

Any memories and comments from people to be captured at a certain time (e.g., the end of a school year, graduation from an institute, retirement, moving jobs, moving away, or events such as a wedding, a birthday, a baby or bridal shower, and so on) can be captured using embodiments of the present invention. As mentioned above, in some embodiments, the compendium is closed for modification after a certain window of time has passed. This provides for capturing memories, emotions and comments from a certain time-period in one's life. In one embodiment, these memories, emotions and comments are captured when they are relatively current/fresh.

### Creation of a Book and Group

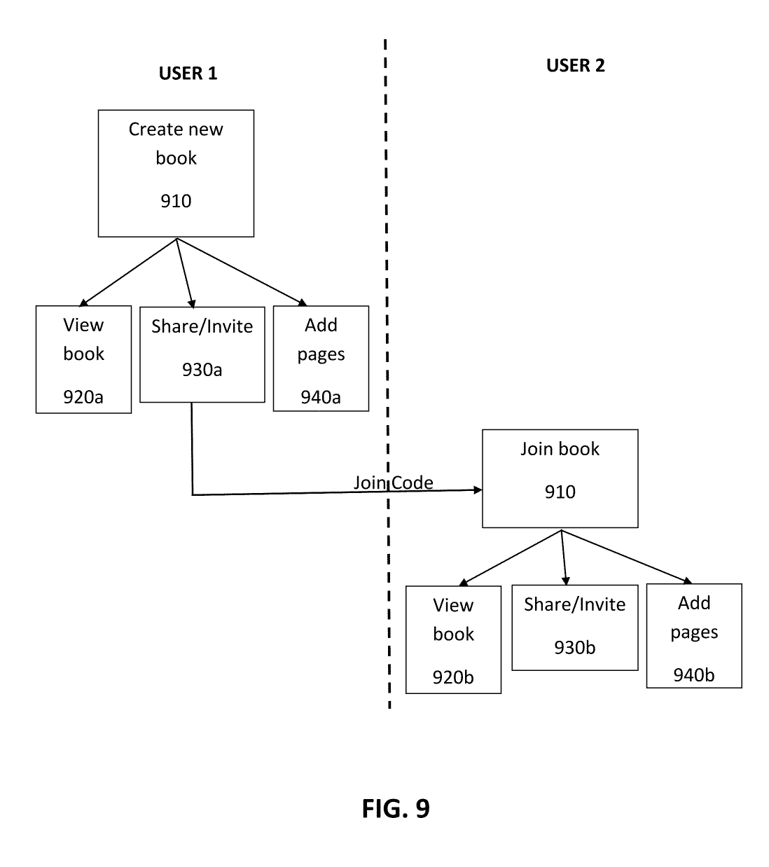

In various embodiments, the compendium and the group that has access to the group can both be created dynamically. FIG. 9 shows a first user (User 1), and a second user (User 2). User 1 can create a new book (910) that is in electronic form and rendered on a screen coupled with an electronic device. The book (910) can be saved as a file and transmitted to a system for physical printing. User 1 can then view the book (920a), share the book with friends/invite friends (930a), or add pages to the book (940a). When User 2 acts on the invitation and joins the book, he or she can also view the book (920b), share the book with friends/invite friends (930b), or add pages to the book (940b). This is described in more detail below.

### Creation of a New Compendium

In accordance with an embodiment, the compendium itself is created in any manner. For example, the compendium may be created using any special software (such as software dedicated to creation of yearbooks), or in any other manner (such as by using MICROSOFT POWERPOINT, MICROSOFT WORD, APPLE KEYNOTE, APPLE COMIC LIFE, and so on). Any type of templates and/or software can be used. The prepared compendium is then uploaded onto the remote server (110) and is accessible by users. In one embodiment, the prepared compendium is uploaded as portable document format (PDF) file.

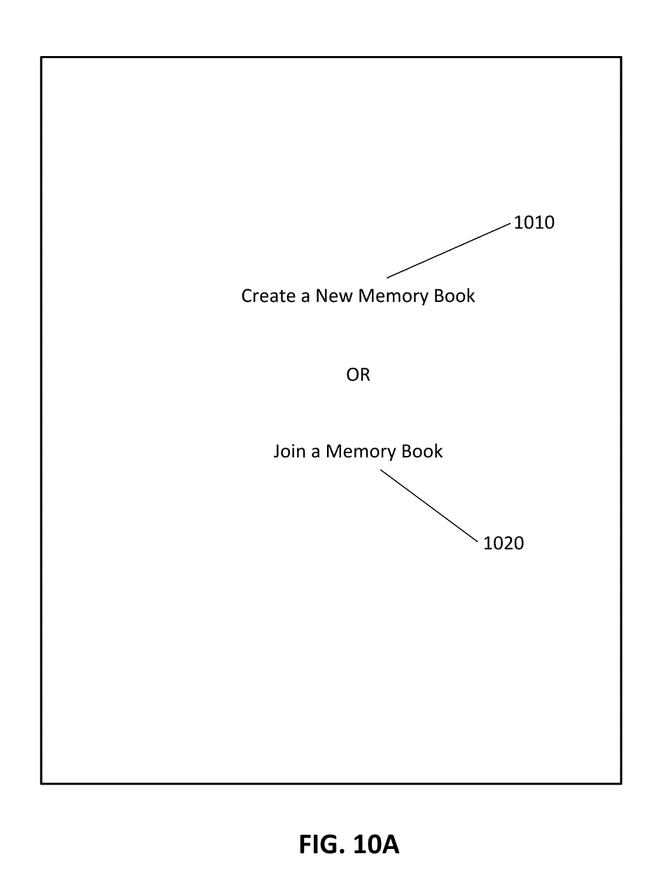

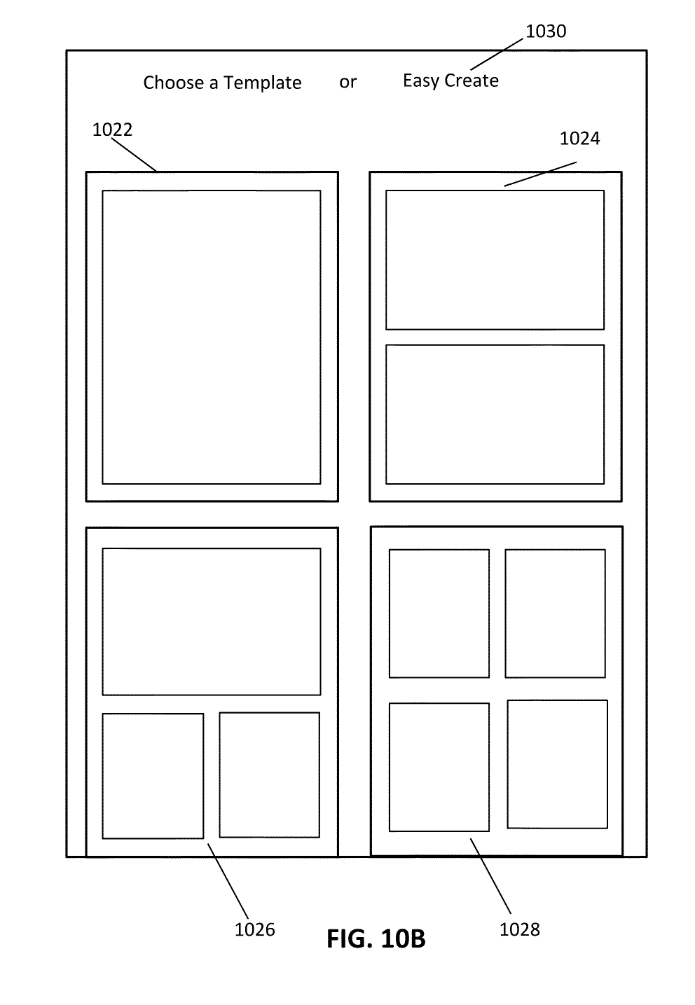

In accordance with an embodiment, a compendium is created within an app. In one embodiment, a user can initiate a compendium by selecting “Create a New Memory Book” (1010) as shown in FIG. 10A. The user can then choose a template (such as templates 1022, 1024, 1026 and 1028 shown in FIG. 10B) to create a collage. In one embodiment, the collage will be presented to the user as a page in the book. In one embodiment, the book is a collection of collages, and the user can interact with these collages like pages in an e-book. In one embodiment, such interaction includes turning pages as in a physical book.

If a user selects a template (such as templates 1022, 1024, 1026, or 1028) for a collage, the user is allowed to take new photos or select existing photos to populate that template. In one embodiment, a user can select or take a photo (using the camera associated with or included in the device 120a . . . n) individually for each slot in the template. In one embodiment, a user can pick multiple photos for a single template, and they are automatically placed in different slots in the template. In one embodiment, the user can manipulate the image being placed into a slot. For instance, the user may be able to zoom in, zoom out, or rotate the image for placing in a slot. In one embodiment, the user may be able to apply filters to the image being placed in a slot.

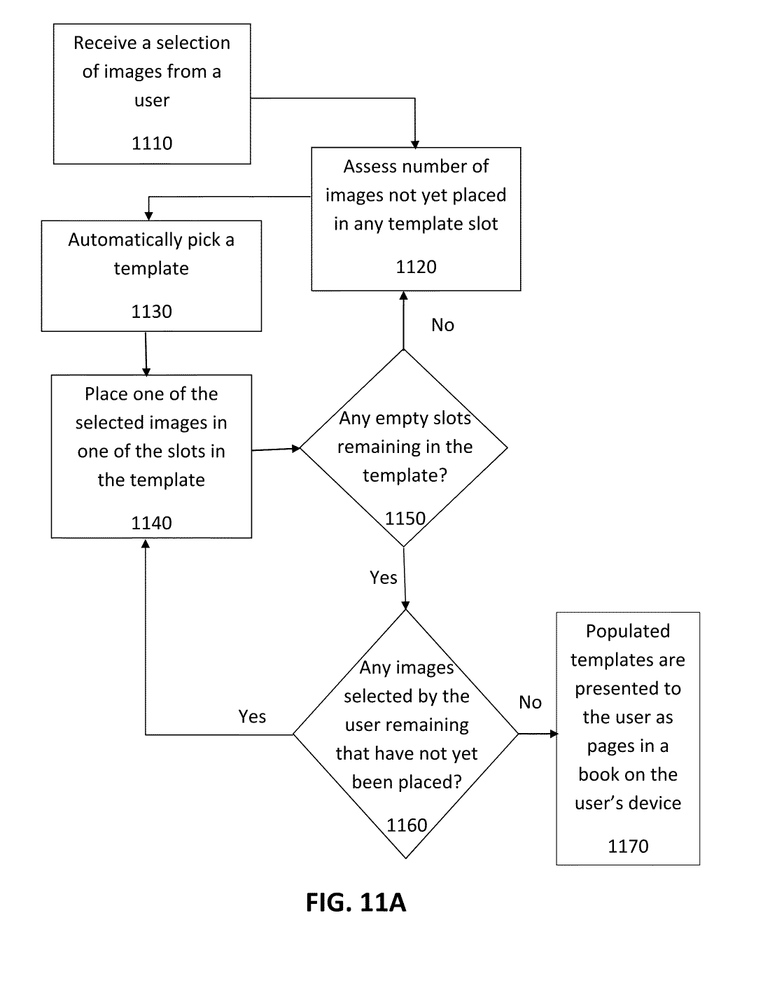

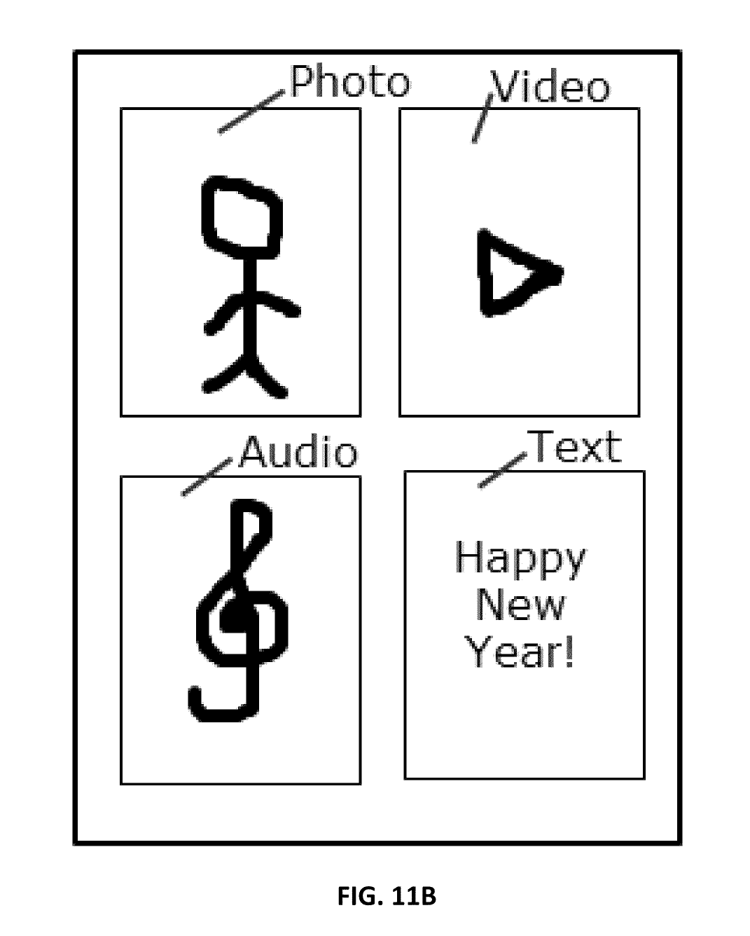

In one embodiment, the user can use the Easy Create (1030) functionality to create a book. Easy Create (1030) is a way of easily and automatically generating a collection of the photographs in the user's camera roll, based on the selection of the photographs by the user. The user experience in using the Easy Create (1030) feature is very smooth. FIG. 11A is a flowchart that shows the Easy Create (1030) option in accordance with an embodiment of the present invention. Once the user selects the Easy Create (1030) option, he or she is allowed to select images (e.g., photos, videos) and/or audios on his or her device (120a, . . . , or 120n). Once the selection is received (1110), a template is automatically picked (1130). In one embodiment, the template is picked (or selected) based on an assessment (1120) of the number of images selected by the user. In one embodiment, the same template is chosen for each page created using the Easy Create (1030) feature.

In one embodiment, a random template is automatically chosen for each page created using the Easy Create (1030) feature. In one embodiment the choice of template chosen for each page depends upon various factors, such as the number of photos selected by the user, the number of slots (e.g., space available to insert a photo) available in each template, the number of times a specific template has already been used in the book, and so on. One of the images selected by the user is placed (1140) in an empty slot in the chosen template. It is determined (1150) whether there are any empty slots remaining in the chosen template. If so, and if it is determined (1160) that there are images selected by the user remaining, which have not yet been placed in any slot in any template, then another image is placed (1140) in another slot in the template. When it is determined (1150) that there are no more empty slots remaining in the template, a new template is picked (1130). This picking (or selection) may again be based on an assessment (1120) of various factors as discussed above. When it is determined (1160) that all the images selected by the user have been placed into slots in templates, the collection created is presented (1170) to the user like a book, and the collages made by populating the photos in the templates are like pages in a book. In one embodiment, the collage created as each populated template corresponds to a page in the book.

In one embodiment, pages automatically created using the Easy Create (1030) feature can then be edited by a user if desired. For example, a user may create several pages using the Easy Create (1030) feature, and then edit each of these pages. For example, the user may zoom in or out on a photo, rotate a photo, add captions, add stickers, add stamps, and so on.

It is to be noted that in addition to the photos, each collage/page can include captions, other text, stickers, stamps and so on. It is to be noted that instead of or in addition to photos, other types of files may also be placed within the slots in the template. These can include, but are not limited to, videos, audio files, and text. Thus it is possible to have a collage of videos, or a collage made up of various of these (e.g., photos and videos), where the collage is presented as a page in a book as described above. See FIG. 11B, which shows a collage that has a photo/image, a video, an audio file and some text in it.

In one embodiment, a theme can be chosen for a book. Such a theme may affect the color of the cover and/or of the other pages in the book, the backgrounds, the positioning and presentation of the photos in the templates, and so on. The themes may also be specific to the occasion or the event. For instance, there may be themes specific to various holidays (e.g., Christmas, Halloween, etc.), graduations, seasons, sports, family reunions, vacations, and so on. In one embodiment, a user can reorder the pages in the photobook so that they are viewable in any different order they choose.

### Viewing the Compendium

Once the book is created, a user can then view the book (920a or 920b are referred to herein as 920). As mentioned above, the user's experience in viewing the book is similar to that in viewing an e-book or e-magazine. The user can interact with the book by flipping through pages, turning the pages, and so on, much like in a physical book or magazine. As mentioned above, flipping a page may include the rendering of the user interface to gradually remove one page from view from a side or corner of the user interface and introduce into view a new page from that same side or corner where the prior page is disappearing from view. Additionally, there may be features such as thumbnails or table of contents that make it easy to navigate through books.

In one embodiment, the book is a collection of collages. Each populated template will be a collage that visually appears as a page in a book, where each page is a collage of one or more images. In one embodiment an entire populated template is saved (such as in a PDF format, an ePub format, a JPEG format, and so on). In one embodiment, the visual presentation to the user of a populated template is like a page in a book, where each page is a collage of one or more images, but the different photos populating the template are saved as independent images (such as in a JPEG format, a PNG format, a GIF format and so on).

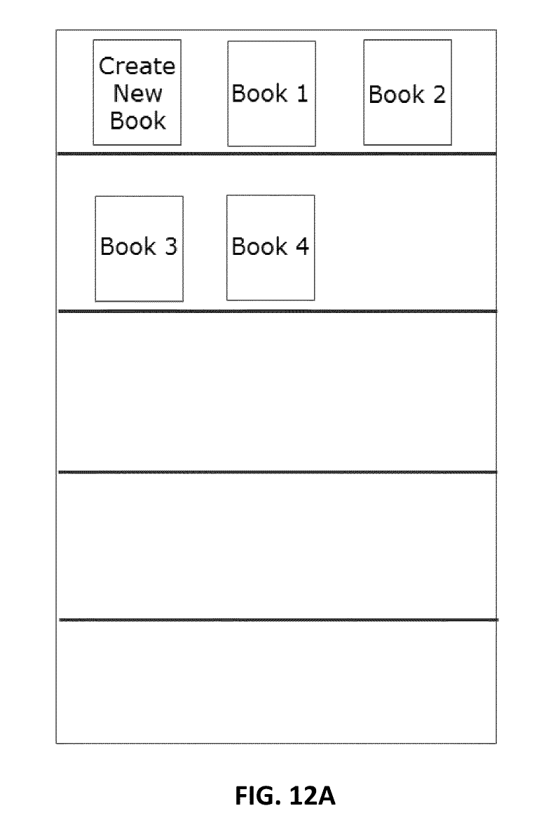

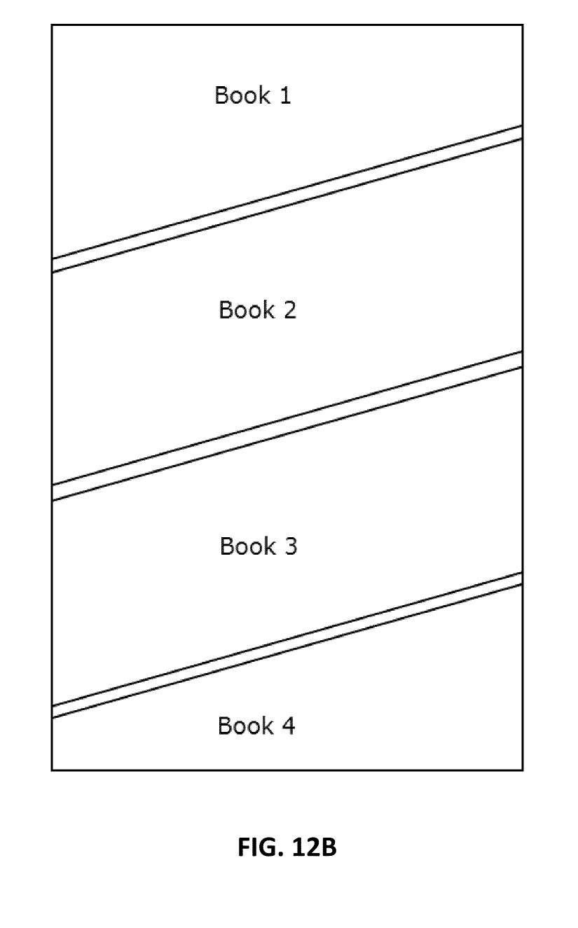

In one embodiment, the compendiums created are presented in the form of books in a bookshelf. See FIG. 12A as an example of this. In one embodiment, a user can see all the books that he/she has created and all the books that he/she has joined, in the bookshelf. In one embodiment, these books are arranged chronologically, with the most recent books being on the top of the bookshelf. In one embodiment, the books may be organized in different ways and/or based on different parameters. In one embodiment, there may be two different bookshelves (accessible, for example, from two different tabs), one for books initiated (created new) by the user, and the other for books he/she has joined.

In one embodiment, there is no bookshelf, but multiple books that the user has created and/or joined are visible to the user. FIG. 12B is an example of such a user interface. In one embodiment, each book is represented by a photo from the book, with or without a title. In one embodiment, each book is represented by a photo collage from the book, with or without a title. In one embodiment, each book is represented by a random photo, with or without a title. In one embodiment, each book is represented by just a title. In one embodiment, the user can scroll through his/her various books.

Sharing with Friends/Inviting Friends

In one embodiment, the user can share a book with friends/invite friends (930a or 930b are referred to herein as 930) to view the book and/or add to it.

In one embodiment, only the user who initiated the creation of the compendium can invite friends (930a) to join the book. In one embodiment, anyone who has joined the book can invite other people (930b) to join the book as well. In this manner, in one embodiment, the group is not pre-defined but rather is created dynamically.

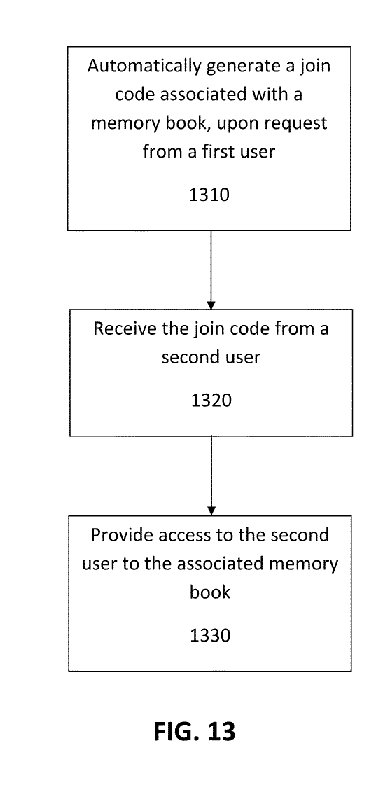

FIG. 13 is a flowchart that shows how users can join the group in accordance with an embodiment. An invitation to join the book is sent (such as an SMS, text message, email, or in-app communication such as a notification) by a user to a person. Such a communication includes, in one embodiment, a join code. This join code is automatically generated (1310) in accordance with an embodiment, and is discussed further below. The user who receives the invitation can then select the “Join a Memory Book” option (1020). Upon receiving (1320) the join code entered by a user, the system provides the user access (1330) the book to which the join code corresponds. In one embodiment, others can be invited to join a book by using some deep linking methodologies, which will provide the user being invited with immediate access to the book being shared, without the use of any join codes. Such deep linking methodologies may be third party technologies.

Once the user has joined, he/she can then, in one embodiment, view the book (920b), share it with others (930b), and add pages to the book (940b). It is to be noted that in various embodiments, only one or more of these functionalities may be available to a user who joins. For example, a user who joins a book may only be able to view the book, but not add new pages to it. As another example, a user may be able to view the book and add new pages to it, but not share it with others/invite others to join the book. In one embodiment, some users may be allowed all functionality, while others may be allowed unrestricted functionality. In one embodiment, a user's level of access granted may be based on the type of join code sent by the user inviting him/her.

In some embodiments, others may be able to view a book, but not add content to it. For example, this may happen if a book is shared on social sites such as FACEBOOK, INSTAGRAM, etc.

In one embodiment, each memory book may be assigned a unique join code. In one embodiment, a new join code may be generated every time an invitation is sent. In one embodiment, a join code is only valid for a certain amount of time from creation, and/or until it is used. After the passage of time or after being used, a join code may no longer be valid for providing access to a particular memory book.

In one embodiment, once a user enters a join code, the book which is joined is visible on the user's bookshelf, as discussed above with reference to FIG. 12A, or otherwise visible to the user, as discussed above with reference to FIG. 12B. An option to create a new book may also be available in the bookshelf view.

In one embodiment, a book may be marked as public, and such public books may be available to be joined by anyone who chooses to do so. For instance, a photographer, painter or author may want a collection of his or her work to be visible to as many people as possible. In one embodiment, such public books may also be visible on a user's bookshelf or more generally, on a user's home screen, if the user chooses to access any such books.

In one embodiment, a memory book or a part thereof may also be shared using social networking platforms such as FACEBOOK, INSTAGRAM, SNAPCHAT, PINTEREST, WHATSAPP, and so on.

### Adding Pages

In one embodiment, the compendium is ultimately created collaboratively, by more than one user. A first user can initiate the creation of the compendium, and one or more users (including the first user) can add on to it. For example, a user can create a compendium as described above. As described above, the user can then choose to invite some friends.

In one embodiment, anybody in the group can add new pages (940a or 940b are referred to herein as 940) to an existing book using templates (such as templates 1022, 1024, 1026 and 1028 shown in FIG. 10B). In one embodiment, anybody in the group can add new pages to an existing book using the Easy Create (1030) functionality. It is to be noted that, in one embodiment, new pages can be added to the book by other users who have been invited to join the book, and also by the user who initially created the book.

In one embodiment, the compendium is updated with the pages that have been added (940) by any user, and every user in the group will see all the pages in the book, including those that have been added by various users. In one embodiment, pages added by a user are appended on to the pages added by another user before him or her (or to the book created by another user before him or her). In one embodiment, the pages created/contributed by various users are mixed or interspersed with each other in the book.

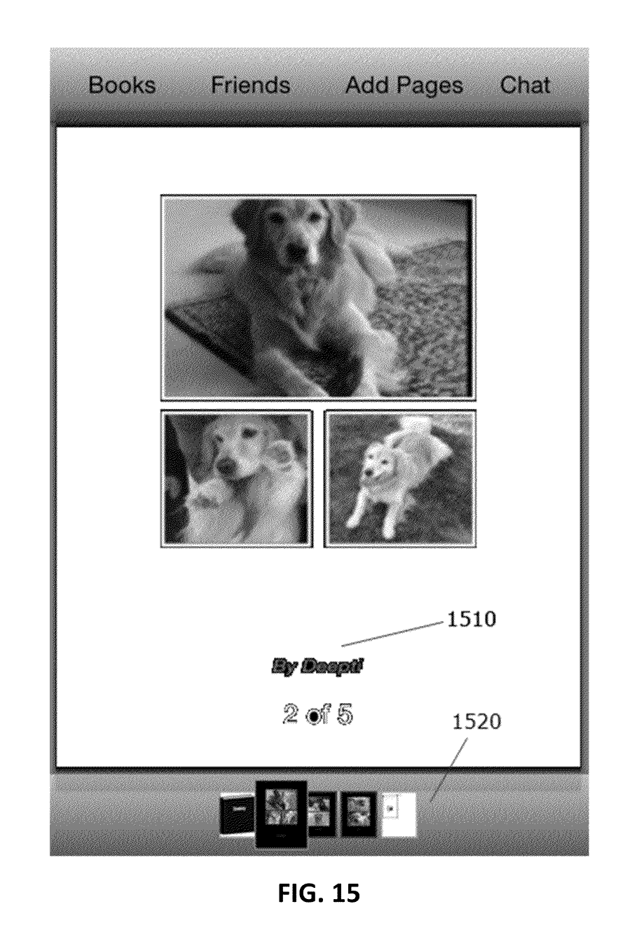

FIG. 15 shows that in one embodiment, the pages being added include identifiers (1510) indicating the user who has added each page. In one embodiment, there may also be an indication of who has initiated creation of the book. In one embodiment, there may be a list of the various contributors to the book. In one embodiment, thumbnails (1520) of the pages in the book can be seen.

### Communications

In one embodiment, the users who have joined a particular book can communicate with each other. In one embodiment such communication can be a group communication, a person-to-person communication, or both.

The group chat can be a communication platform where all the users who have joined a particular group can communicate with each other, comment on the book, and so on. In one embodiment, the group chat is visible to everyone who has joined the book, and each of the people who have joined the group can participate in the group chat. In one embodiment, smaller sub-groups may be created within the users who have joined a particular group, and the group chats may be used for such smaller sub-groups as well.

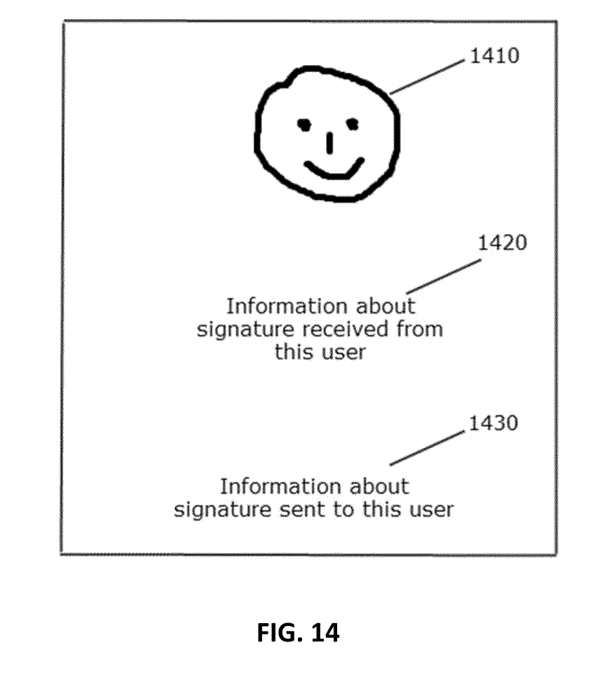

In one embodiment, the signatures are a person-to-person communication, and only the user signing and the user receiving the signature can see it. In one embodiment, the person-to-person communications can be managed and accessed from a single screen, as shown in FIG. 14. As the person-to-person communication proceeds, varying statuses/messages are displayed, and different actions may be taken from this screen. For instance, these may include a user's image (1410), information about signature from the user in the photo (1420) such as “Ask for Signature”, “Signature Requested”, “Signature Received”, “See Signature Received”, as well as information about signature to user in the photo (1420) such as “Sign Now”, “See What You've Signed” and so on.

### Additional Considerations

Beneficial advantages of some embodiments include allowing collection of personalized content (such as signatures or freeform messages captured as images or in other ways) from various different users for only the requesting user to see. An example of this is the composite signature view as shown in FIG. 4G. The requesting user can then provide authorization for others to see the personalized content through the app itself, or through social networking options such as FACEBOOK, INSTAGRAM, PINTEREST, etc. Allowing for collection and maintenance of messages from disparate sources is a benefit of some embodiments.

In one embodiment, the signatures received by a user are provided in a composite view with multiple signatures on a page, and these pages are added on as the ending pages in the book, as seen only by the user requesting those signatures. Other users seeing the book will see their own received signatures as the ending pages in their books. Another benefit of some embodiments is the ability to create and/or interact with a compendium which is an electronic representation of a physical book (along with electronic captures of signatures or and other freeform messages/images from users).

To the extent possible, everything described in one embodiment or under one sub-section above can be incorporated into another embodiment or into descriptions under other sub-sections. For instance, in one embodiment, the signing functionality (requesting signatures and signing) described above with reference to FIGS. 7A-7G is included along with the book created dynamically by a dynamically formed group. As another example, the view of multiple books described with reference to FIGS. 12A and 12B is included in the embodiments described above for pre-defined groups.

The various embodiments can be implemented in software, firmware, hardware, or any combination thereof. The embodiments discussed herein are in no way meant to limit the scope. It should be noted that the language used in the specification has been principally selected for readability and instructional purposes, and may not have been selected to delineate or circumscribe the disclosed subject matter.

What is claimed is:

1. A computer-implemented method for obtaining messages, the computer-implemented method comprising:
displaying a plurality of images, each image associated with an individual;
receiving an input from a user identifying one of the plurality of images;
sending a request for a message to a second user associated with the identified one of the plurality of images;
receiving the message from the second user;
receiving an input from the user identifying a second of the plurality of images;
sending a request for a message to a third user associated with the identified second of the plurality of images;
receiving the message from the third user, at least one of the message from the second user and the message from the third user comprising a free-form message embodied as a captured image; and
displaying the message received from the second user and the message received from the third user with a thumbnail image of the third user in a single view, the single view viewable only by the user.

2. The computer-implemented method of claim 1 wherein the single view is presented on a touch-sensitive device.

3. The computer-implemented method of claim 2, wherein the touch-sensitive device is one of a group consisting of a smartphone, a tablet, or a phablet.

4. The computer-implemented method of claim 2, wherein the input from the user identifying one of the plurality of images comprises a tap on the one of the plurality of images.

5. An electronic compendium belonging to a user in a group, the electronic compendium comprising:
a static portion rendered on a display of an electronic device; and
a dynamic portion which is updated with at least one signature received from at least one of a plurality of members in the group, wherein the electronic device receives the at least one signature in response to sending an electronic request for a signature from the one of the plurality of members in the group, the signature received structured as a free-form message embodied as a captured image.

6. The electronic compendium of claim 5, wherein the compendium is a yearbook.

7. The electronic compendium of claim 5, where in the compendium is a memory book.

8. A user interface for obtaining signatures, the user interface comprising:
displaying a plurality of images associated with a plurality of users;
allowing a user to select one of the plurality of images; and
modifying the displayed plurality of images to provide the user with a visual indication that a request for a signature has been sent to the one of the plurality of users associated with the selected one of the plurality of images.

9. A user interface for displaying signatures, the user interface comprising:
displaying a plurality of signatures received from a plurality of users in a single page view.

10. The user interface of claim 9, further comprising:
allowing a page-flipping type interaction with a plurality of the single page views.

11. A computer-implemented method for collaboratively creating an electronic compendium, the computer-implemented method comprising:
allowing a first user to initiate creation of the electronic compendium on a touch-sensitive device, the electronic compendium consisting of at least one collage, wherein the collage includes at least one image, and wherein the collage is visually presented as a page in an electronic book;
allowing the first user to share the electronic compendium with a second user;
allowing the second user to add at least a second collage to the electronic compendium, wherein the second collage is presented as a second page in the electronic book; and
visually presenting on the touch-sensitive device to the first user, the first collage and the second collage as the first page and the second page in the electronic book.

12. The computer-implemented method of claim 11, wherein the step of allowing a first user to initiate creation of the electronic compendium on the touch-sensitive device comprises:
allowing the first user to select at least one image on the touch-sensitive device; and placing the at least one image in at least one slot in at least one template.

13. The computer-implemented method of claim 12, further comprising:
allowing the first user to select the at least one template.

14. The computer-implemented method of claim 12, further comprising:
automatically selecting the at least one template based upon a number of images selected by the first user.

15. The computer-implemented method of claim 11, wherein the step of allowing the first user to share the electronic compendium with the second user comprises:
generating a join code; and
providing the join code to the first user for sharing with the second user.

16. The computer-implemented method of claim 15, further comprising:
allowing the second user to add the second collage to the electronic compendium after entering the join code shared by the first user.

17. The computer-implemented method of claim 11, further comprising:
receiving a message from the second user for the first user;
visually presenting the electronic compendium to the first user with a third page including the message on it.

18. A computer-implemented method to create a collection of collages from a plurality of images, the computer-implemented method comprising:
receiving a selection of a plurality of images from a user via a user device;
automatically selecting a first template with at least one slot for one of the plurality of images;
placing one of the plurality of images in the at least one slot in the first template;
determining whether at least one slot in the first template is available;
determining whether at least one of the plurality of images is remaining to be placed;
in response to determining that at least one slot in the first template is available,
and in response to determining that at least one of the plurality of the images is remaining to be placed, placing the a second of the plurality of images in the at least one remaining slot to create a first collage; and
repeating each determining step until there are no more slots in the first template available.

19. The computer-implemented method of claim 18, further comprising:
in response to determining that at least one of the plurality of images is remaining to be placed, automatically selecting a second template with at least one slot.

20. The computer-implemented method of claim 19, further comprising:
visually presenting the first collage to the user as a first page in a book on the user device.

21. The computer-implemented method of claim 18, wherein the step of automatically selecting the first template with at least one slot for one of the plurality of images comprises:
assessing a number of the plurality of images selected by the user.
